(19) United States
(12) Patent Application Publication
(10) Pub. No.: US 2009/0160084 A1
(43) Pub. Date: Jun. 25, 2009

(54) MANUFACTURING METHOD OF SEMICONDUCTOR DEVICE

(76) Inventors: Bunshi Kuratomi, Tokyo (JP); Fukumi Shimizu, Tokyo (JP); Takafumi Nishita, Tokyo (JP)

Correspondence Address: MILES & STOCKBRIDGE PC, 1751 PINNACLE DRIVE, SUITE 500, MCLEAN, VA, 22102-3833, US

(21) Appl. No.: 12/158,289

(22) PCT Filed: Dec. 28, 2006
(86) PCT No.: PCT/JP2006/326183

§ 371 Date: Jun. 19, 2008

(51) Int. Cl. B29C 45/00

(52) U.S. Cl. 264/219

(57) ABSTRACT

A lead frame is equipped between an upper die with which a gate port and an air vent part are not formed in a cavity part 12a and a lower die in which a gate port 15f is formed in one place of a corner of a cavity part 15a and an air vent part is not formed. After decompressing the inside of the die formed of the cavity parts 12a and 15a by clamping the upper die and the lower die with the clamp pressure of intermediate pressure, mold resin is allowed to flow in the die. Residual air is exhausted while allowing mold resin to flow in the die formed of the cavity parts 12a and 15a by once clamping the upper die and the lower die with low-pressure clamp pressure. Then, the mold resin which filled up in the die formed of the cavity parts 12a and 15a is formed by clamping the upper die and the lower die with high-pressure clamp pressure.

### TECHNICAL FIELD

The present invention relates to the manufacturing technology of a semiconductor device, and particularly relates to an effective technology in the application to the method of doing the resin seal of the semiconductor device with a transfer mold method.

### BACKGROUND ART

For example, the technology that at the time of injection of melting resin, a clearance is formed throughout the contact surface of an upper-die cavity block and the lead frame upper surface, movement filling of the melting resin is done into a cavity by applying low pressure to melting resin, a preliminary mold clamp is performed by exhausting from the above-mentioned clearance, the clearance between the whole region on the contact surface of an upper-die cavity block and the upper surface of a lead frame is eliminated after that, the transfer pressure of melting resin is raised, and pressurization and sealing of melting resin is done is disclosed (for example, refer to Patent Reference 1).

The technology that the clamp surface pressure which clamps molded articles is set as the clamp pressure which enables discharge of air from a cavity and prevents resin leaks out from a cavity, where molded articles are clamped with this clamp pressure, a mold clamp is done until resin is filled up in a cavity, and air is discharged from the inside of a cavity, and after setting clamp surface pressure as the closing pressure that resin does not leak from a cavity with the molding pressure at the time of forming the resin filled up in the cavity, a resin molding is done to resin, applying molding pressure is disclosed (for example, refer to Patent Reference 2).

The mold method which supplies a molded article and resin between an upper die and a lower die where die opening is done, does the mold clamp of an upper die and the lower die after doing the air seal of the resin molding region and doing evacuation, and does the resin molding of the molded article is disclosed (for example, refer to Patent Reference 3).

The metallic mold for resin seals which has an air vent which is formed in the peripheral part of a cavity and does ventilation of the air in a cavity to the external world, a passage for suction formed so that it might be open for free passage to this air vent, and a suction opening which is formed in the passage for suction and leads to the metallic mold outside is disclosed (for example, refer to Patent Reference 4).

The apparatus for resin sealing whose metal mold clamps a substrate, and sends out sealing resin from a resin filling portion to a cavity recess while applying resin pressure, and which sucks the air of the gap part of a semiconductor chip and a substrate from a substrate exhaust hole by an air suction means, and does the resin seal of the gap part is disclosed (for example, refer to Patent Reference 5).

The resin molding method that when clamping a molded article with a metal mold and doing resin filling, while raising transfer pressure gradually, according to the increase of pressure of transfer pressure, the mold clamp force over a molded article is raised gradually, and resin filling is done, and after predetermined time passes since the cure start time at the time of a cure, while easing transfer pressure gradually, the cure is done making the mold clamp force over a molded article ease gradually according to transfer pressure is disclosed (for example, refer to Patent Reference 6).

[Patent Reference 1] Japanese patent laid-open No. 2000-100845 (paragraph [0033]-[0042], FIG. 3-FIG. 7)

[Patent Reference 2] Japanese patent laid-open No. 2005-88395 (paragraph [0019]-[0024], FIG. 2-FIG. 4)

[Patent Reference 3] Japanese patent laid-open No. 2005-53143 (paragraph [0018]-[0020], FIG. 1-FIG. 3)

[Patent Reference 4] Japanese patent laid-open No. Hei 7 (1995)-88901 (paragraph [0012]-[0014], FIG. 1)

[Patent Reference 5] Japanese patent laid-open No. 2001-267345 (paragraph [0021]-[0027], FIG. 4)

[Patent Reference 6] Japanese patent laid-open No. Hei 5 (1993)-147063 (paragraph [0010]-[0011], FIG. 1)

### DISCLOSURE OF THE INVENTION

### Problem to be Solved by the Invention

By the transfer mold method, generally in order to improve the mold-release characteristic of mold resin (for example, epoxy resin) from a metal mold, wax is added in mold resin. However, there is a problem that this wax adheres on the surface of a cavity, and oxidizes with the heat of a metal mold as the number of extraction times increases, and the mold-release characteristic from the metal mold of mold resin worsens originating in this oxidized wax. Then, after performing the mold of 1000-1500 shots using mold resin, cleaning of 5-6 shots using cleaning resin (for example, melamine system resin) was performed, and mold resin adhering to a metal mold is removed. Cleaning resin has the character which strips off compulsorily the mold resin which is originated in the oxidized wax and adhered to the metal mold.

However, since the mold-release characteristic of mold resin from a metal mold is not fully recovered even if this cleaning is carried out, after performing the above-mentioned cleaning, the mold of 2-3 shots which uses resin which can improve the mold-release characteristic of mold resin from a metal mold (for example, wax system resin; hereafter only described as resin for mold release) is further performed, and improvement in a mold-release characteristic of mold resin from a metal mold is aimed at.

By the way, when injection mold resin into metal mold, the air vent part (escaping passages of air) is formed in the center or corner of each cavity part so that the air by which the trap is done into the passage part and cavity part of a metal mold may not be involved in mold resin. Although the size of an air vent part changes with package specifications, for example by QFP (Quad Flat Package), the air vent part of the width of about 0.5-1 mm and depth of 30-45 cm is formed in three corner parts.

However, it will be easy to be in the state where the resin for mold release mentioned above adhered to this narrow air vent part. Where resin for mold release has been adhered, when a mold is performed, air will be involved in mold resin without air being unremovable, and a non-filling failure will occur in mold resin. Then, although manual operation is removing resin for mold release adhering to an air vent part, great time is needed for removal of resin for mold release adhering to an air vent part. For example, since the metal mold which does the mold of the matrix frame is equipped with 100-300 air vent parts, removal of resin for mold release adhering to an air vent part takes about 2 hours per time.

Although there is a means to exhaust the air in a cavity part compulsorily out of a cavity part by the pressure reduction mold, the air vent part is used for suction of air with almost all metal molds. For this reason, since the inside of a cavity part cannot be decompressed but the exhaust gas of the air to the outside of a cavity part becomes impossible when an air vent part is got blocked, it is hard to become an effective means to cancel the non-filling failure of mold resin.

There is a method which loses and seals the clearance between the whole region of an upper die and a lower die after being filled up with mold resin in a cavity part, applying low pressure to mold resin where the clearance between 30-40 μs is formed throughout the upper die and lower die of a metal mold and exhausting from the above-mentioned clearance. However, since mold resin is melting resin, the problem of mold resin leaking from a clearance or the air exhausted being involved in mold resin and a void formed in the inside and the outside of a package occurs.

In order to perform a pressure reduction mold and to prevent invasion of the air from other than a pressure reduction part, it is necessary to process the trench for ceilings into a metal mold and to install O ring for heatproofs in the processed part. However, since the space which attaches the O ring for ceilings is needed for the outside of a lead frame surface, a metal mold becomes large-sized and a mold press also becomes large-sized in connection with this. Since an O ring usually consists of silicon system rubber, strength is weak, when foreign substances (for example, resin waste after a mold etc.) are put between an O ring and the trench for ceilings, an O ring is damaged, air invades from the part, and the amount of pressure reduction falls. Therefore, control of an O ring is needed.

A purpose of the present invention is to offer the technology in which shortening of the cleaning time of the metal mold for semiconductor chip sealing can be aimed at.

Other purpose of the present invention is to offer the technology which can improve the manufacturing yield of semiconductor products by preventing the non-filling failure of mold resin.

The above-described and the other purposes and novel features of the present invention will become apparent from the description herein and accompanying drawings.

### Means for Solving the Problems

Of the inventions disclosed in the present application, typical ones will next be summarized briefly.

The manufacturing method of the semiconductor device by the present invention comprises the steps of: equipping with a lead frame to which bonding of a semiconductor chip has been done between an upper die with which a gate port and an air vent part are not formed in a cavity part and a lower die in which a gate port is formed in one place of a corner of a cavity part and an air vent part is not formed, and decompressing the inside of the die which is formed by the cavity part of the upper die and the cavity part of the lower die by fastening the upper die and the lower die with clamp pressure of intermediate pressure; stopping the pressure reduction in the die formed by the cavity part of the upper die and the cavity part of the lower die, and allowing the mold resin which seals the semiconductor chip to flow into the die in a state where the upper die and the lower die are fastened with the clamp pressure of intermediate pressure; discharging the residual air in the die while allowing the mold resin to flow into the die which is formed by the cavity part of the upper die and the cavity part of the lower die by fastening the upper die and the lower die with low-pressure clamp pressure; and forming the mold resin in the die which is formed by the cavity part of the upper die and the cavity part of the lower die by fastening the upper die and the lower die with high-pressure clamp pressure.

The manufacturing method of the semiconductor device by the present invention comprises the steps of: equipping with a lead frame to which bonding of a semiconductor chip, which has a gate part formed in a first corner part of a package region of a unit frame and a flow cavity part which is formed in a second corner at a position symmetrical to the first corner part and has a vent formed therein, has been done between an upper die with which a gate port and an air vent part are not formed in a cavity part and a lower die in which a gate port is formed in one place of a corner of a cavity part and an air vent part is not formed so that the gate port of the upper die and the gate part of the lead frame correspond to each other; and allowing mold resin which seals the semiconductor chip to flow into the die formed by the cavity part from a pot part via the resin inflow path formed by fastening the upper die and the lower die and the gate port, and exhausting the air in the die formed by the cavity part from the vent formed in the flow cavity part.

### EFFECT OF THE INVENTION

Advantages achieved by some of the most typical aspects of the invention disclosed in the present application will be briefly described below.

By not forming an air vent part in the upper die and the lower die of a metal mold, removal of resin for mold release adhering to an air vent part becomes unnecessary, and the cleaning time of a metal mold can be shortened. Also, by not forming an air vent part, the inconvenience of pressure reduction in the cavity by overlooking of removal of resin for mold release adhering to an air vent part or a generation of the foreign substance by sudden peeling of resin for mold release adhering to an air vent part and the non-filling failure of mold resin resulting from adhesion of the foreign substance can be prevented, and the manufacturing yield of semiconductor products can be improved.

### BRIEF DESCRIPTION OF THE DRAWINGS

FIG. 1 is a plan view showing an example of the contour of the lead frame by Embodiment 1;

FIG. 2 is a flow diagram showing an example of the manufacturing method of the semiconductor device by Embodiment 1;

FIGS. 3A to 3C are explanatory diagrams for a lead frame to explain the molding step of FIG. 2 in detail, FIG. 3A is a lead frame before a resin inflow processing, FIG. 3B is a lead frame after a resin inflow processing, and FIG. 3C is a lead frame by which unload processing is done after gate break processing;

FIGS. 4A and 4B are plan views showing the example of outline structure of the metal mold by Embodiment 1, FIG. 4A is a plan view of an upper die, and FIG. 4B is a plan view of a lower die;

FIGS. 5A and 5B are drawings showing the example of section structure between A-A′ in the metal mold of FIGS. 4A and 4B, FIG. 5A is a cross-sectional view of an upper die, and

FIG. 5B is a cross-sectional view of a lower die;

FIGS. 6A and 6B are enlarged plan views of the cavity part of the metal mold of FIGS. 4A and 4B, FIG. 6A is a plan view of an upper die, and FIG. 6B is a plan view of a lower die;

FIG. 7 is a cross-sectional view showing the example of outline structure of the decompressing part of the metal mold by Embodiment 1;

FIGS. 8A to 8C are examples of the operating sequence in the air exhaust processing and the resin inflow processing by Embodiment 1, FIG. 8A is a press position of the plunger for pin raising of a lower die, FIG. 8B is clamp pressure which sandwiches a lead frame, and FIG. 8C is a transfer position of the plunger which extrudes mold resin from the pot part of a lower die;

FIGS. 9A to 9C are drawings showing the example of outline structure of the metal mold which explains the air exhaust processing and the resin inflow processing by Embodiment 1 one by one, FIG. 9A is a cross-sectional view of the upper die and lower die of a decompressing part, FIG. 9B is a cross-sectional view of the upper die and lower die of a resin inflow part, and FIG. 9C is a principal part plan view with which the upper die and lower die of the lead frame installation section are overlapped;

FIGS. 10A to 10C are drawings showing the example of outline structure of the metal mold of the same part as FIGS. 9A to 9C in the air exhaust processing and the resin inflow processing following FIGS. 9A to 9C;

FIGS. 11A to 11C are drawings showing the example of outline structure of the metal mold of the same part as FIGS. 9A to 9C in the air exhaust processing and the resin inflow processing following FIGS. 10A to 10C;

FIGS. 12A to 12C are drawings showing the example of outline structure of the metal mold of the same part as FIGS. 9A to 9C in the air exhaust processing and the resin inflow processing following FIGS. 11A to 11C;

FIGS. 13A to 13C are drawings showing the example of outline structure of the metal mold of the same part as FIGS. 9A to 9C in the air exhaust processing and the resin inflow processing following FIGS. 12A to 12C;

FIGS. 14A to 14C are drawings showing the example of outline structure of the metal mold of the same part as FIGS. 9A to 9C in the air exhaust processing and the resin inflow processing following FIGS. 13A to 13C;

FIGS. 15A to 15C are other examples of the operating sequence in the air exhaust processing and the resin inflow processing by Embodiment 1, FIG. 15A is a press position of the plunger for pin raising of a lower die, FIG. 15B is clamp pressure which sandwiches a lead frame, and FIG. 15C is a transfer position of the plunger which extrudes mold resin from the pot part of a lower die;

FIG. 16 is a graphical representation showing the rate of incidence of deformation of the wire which connects the pad on a semiconductor chip and the lead of a lead frame;

FIG. 17 is a graphical representation showing the rate of incidence of a void and a non-filling part formed in mold resin;

FIG. 18 is a plan view showing an example of the contour of the lead frame by Embodiment 2;

FIG. 19 is an enlarged plan view of the flow cavity part formed in the lead frame by Embodiment 2;

FIGS. 20A and 20B are enlarged views of the resin reservoir part formed in the lead frame by Embodiment 2, FIG. 20A is an enlarged plan view of a resin reservoir part, and FIG. 20B is an enlarged sectional view of the vent formed in the resin reservoir part;

FIG. 21 is an enlarged plan view of the first modification of the flow cavity part formed in the lead frame by Embodiment 2;

FIG. 22 is an enlarged plan view of the second modification of the flow cavity part formed in the lead frame by Embodiment 2;

FIGS. 23A and 23B are explanatory diagrams for an example of a lead frame to explain the molding step by Embodiment 2, FIG. 23A is a lead frame before mounting a semiconductor chip on the tab of a frame, and FIG. 23B shows a lead frame by which mold resin sealing was done, after mounting a semiconductor chip; and

FIGS. 24A and 24B are explanatory diagram for other examples of a lead frame to explain the molding step by Embodiment 2, FIG. 24A is a lead frame before mounting a semiconductor chip on the tab of a frame, and FIG. 24B shows a lead frame by which mold resin sealing was done, after mounting a semiconductor chip.

### BEST MODE FOR CARRYING OUT THE INVENTION

Hereafter, embodiments of the invention are explained in detail based on drawings. In all the drawings for describing the embodiments, members of a like function will be identified by like reference numerals in principle and overlapping descriptions will be omitted.

In the below-described embodiments, a description will be made after divided into plural sections or in plural embodiments if necessary for convenience sake. These plural sections or embodiments are not independent each other, but in relation such that one is a modification example, details or complementary description of a part or whole of the other one unless otherwise specifically indicated.

In the below-described embodiments, when a reference is made to the number of elements (including the number, value, amount and range), the number is not limited to a specific number but may be equal to or greater than or less than the specific number, unless otherwise specifically indicated or principally apparent that the number is limited to the specific number. In the below-described embodiments, it is needless to say that the constituting elements (including element steps) are not always essential unless otherwise specifically indicated or principally apparent that they are essential. Similarly, in the below-described embodiments, when a reference is made to the shape or positional relationship of the constituting elements, that substantially analogous or similar to it is also embraced unless otherwise specifically indicated or principally apparent that it is not. This also applies to the above-described value and range.

In the drawings used in the below-described embodiments, even a plan view is sometimes partially hatched for facilitating understanding of it.

In all the drawings for describing the embodiments, members of a like function will be identified by like reference numerals in principle and overlapping descriptions will be omitted. Hereafter, embodiments of the invention are explained in detail based on drawings.

### Embodiment 1

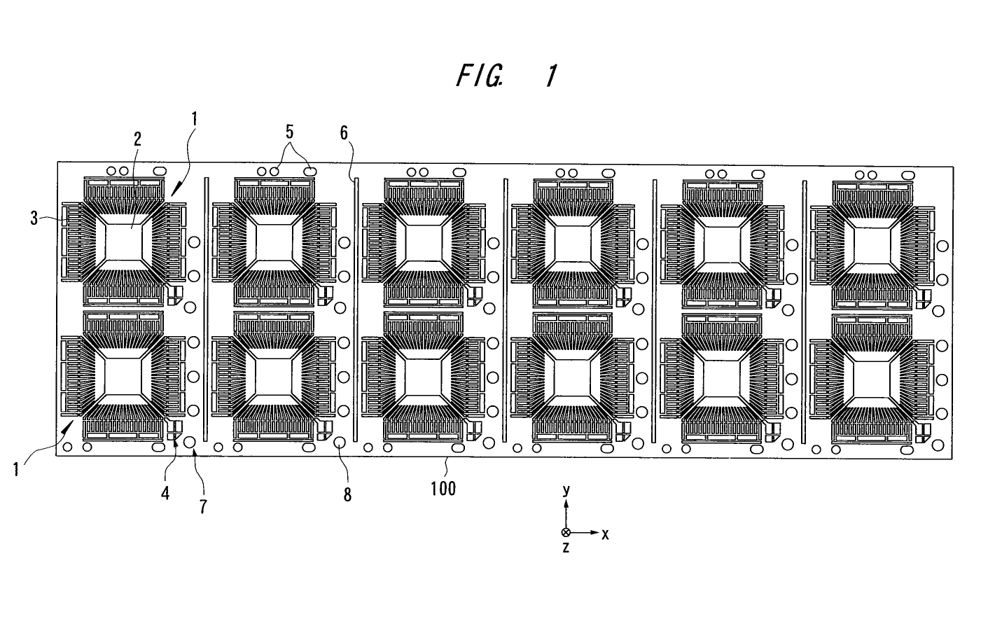

FIG. 1 is a plan view showing an example of the contour in the lead frame by Embodiment 1. The lead frame shown in FIG. 1 is a lead frame of a QFP(s)-oriented matrix type, for example. It has the structure that unit frame 1 corresponding to one semiconductor product has been arranged at 6 rows by 2 columns as making long-side direction (the direction of an x-axis) of a lead frame into a column and making the direction (the direction of a y-axis) which intersects perpendicularly with the direction of this column into a row. The lead frame of the matrix type in Embodiment 1 has two or more unit frames 1 in each of a row and column. In Embodiment 1, the direction of the thickness of a lead frame which intersects perpendicularly with the above-mentioned x-axis and y-axis is used as a direction of a z axis.

Each unit frame 1 includes tab 2 on which a semiconductor chip is mounted according to a die-bonding step, many leads 3 which are formed so that tab 2 may be surrounded and are connected with the pad on a semiconductor chip by a wire-bonding step, gate part 4 which is formed in the corner part of the package region (cavity part) used as a resin seal region including a semiconductor chip and constitutes a region of the entrance at the time of allowing mold resin to flow in a package region, etc. A plurality of holes 5, slits 6, etc. are formed on the circumference of each unit frame 1 and between each unit frame 1. These are for easing strain of the lead frame accompanying the inflow of mold resin and for positioning of a lead frame. Further, between unit frames 1 which adjoin in a column direction, runner part 7 used as a resin inflow path is formed. This runner part 7 has a pattern of a plurality of holes 8.

FIG. 2 is a flow diagram showing an example of the process flow in the manufacturing method of the semiconductor device by Embodiment 1. In FIG. 2, the molding step by molding equipment, the cutting step by a cutting device, and the plating step by plating equipment are performed in order using the lead frame as shown by FIG. 1.

The molding step includes load processing (S200) which carries in equipment the lead frame by which bonding was done and which is set to a predetermined position, the resin inflow processing (S201) which allows mold resin to flow in by using an upper die and a lower die to the set lead frame, gate break processing (S202) in which mold resin of a runner part is removed from a cull part which remained by resin inflow processing, unload processing (S203) which removes the lead frame after gate break processing from a predetermined position, and carries it out to the next equipment, and etc.

The cutting step includes gate cutting processing (S204) which removes the mold resin of a gate part which remained by the resin inflow processing (S201) mentioned above, dam cut processing (S205) in which the dam bar which has connected between the leads of a lead frame and the remaining resin accumulated in the circumference of this dam bar are removed, and etc. The plating processing (S206) which performs solder plating etc. to the outer lead which turns into a lead of the outside of mold resin and turns into a lead which leads to an inner lead is included in the plating step.

In the present invention, the resin injection processing performed using an upper die and a lower die by the molding step of a lead frame has been the main features. Subsequent explanation clarifies about the detail, effect, etc.

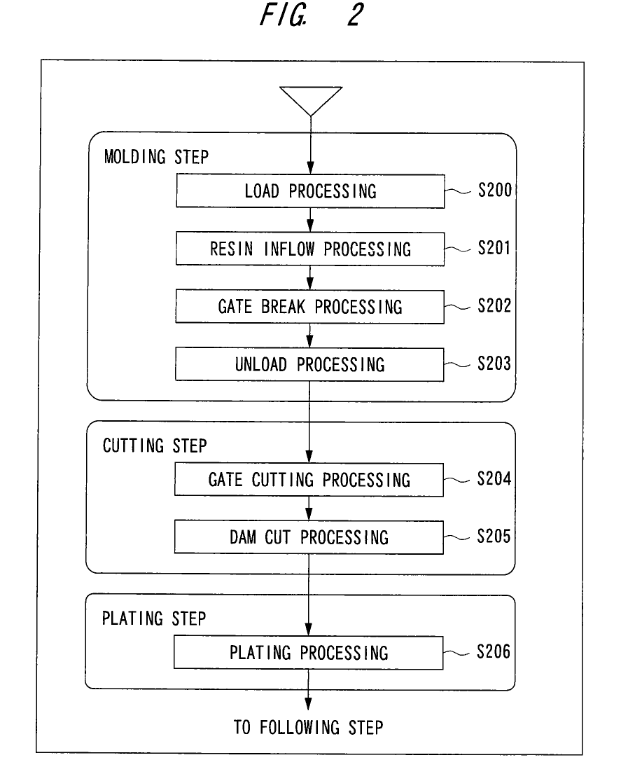

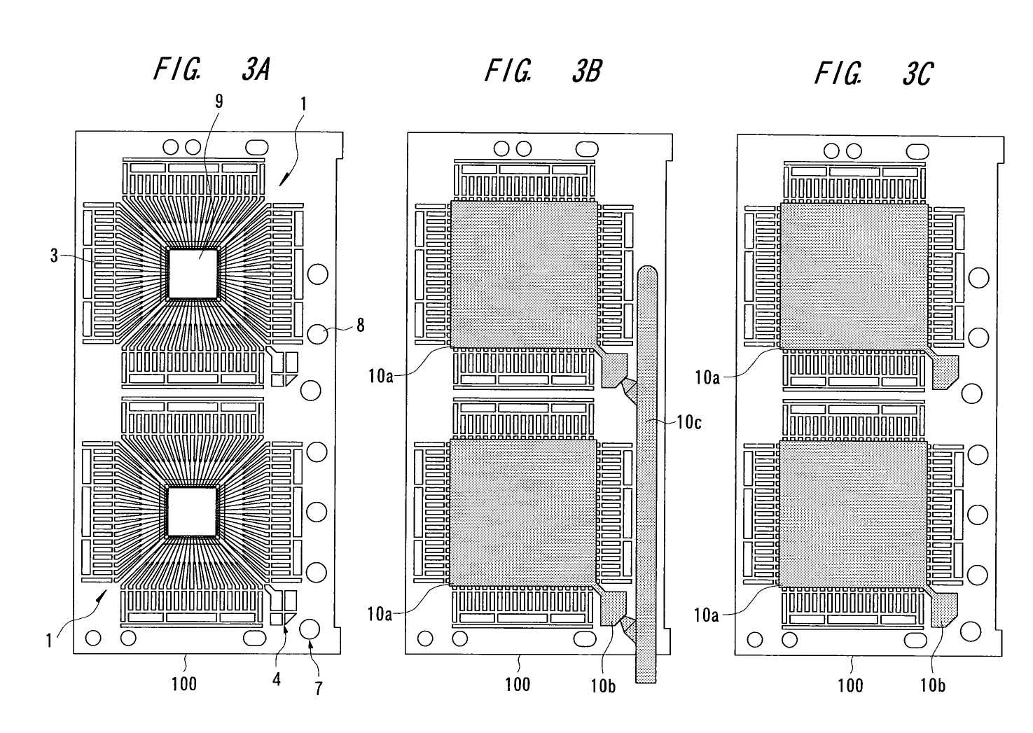

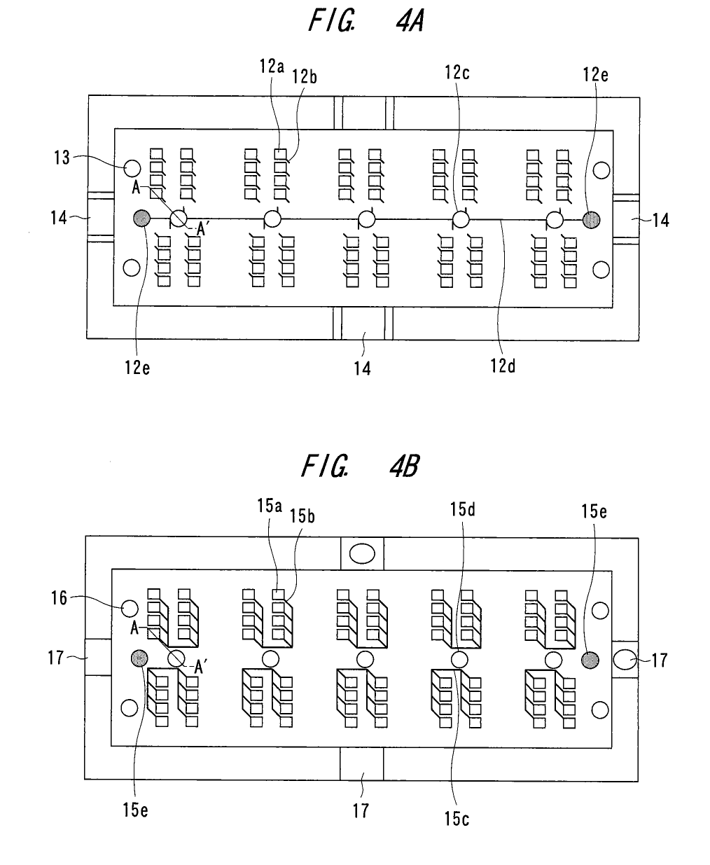

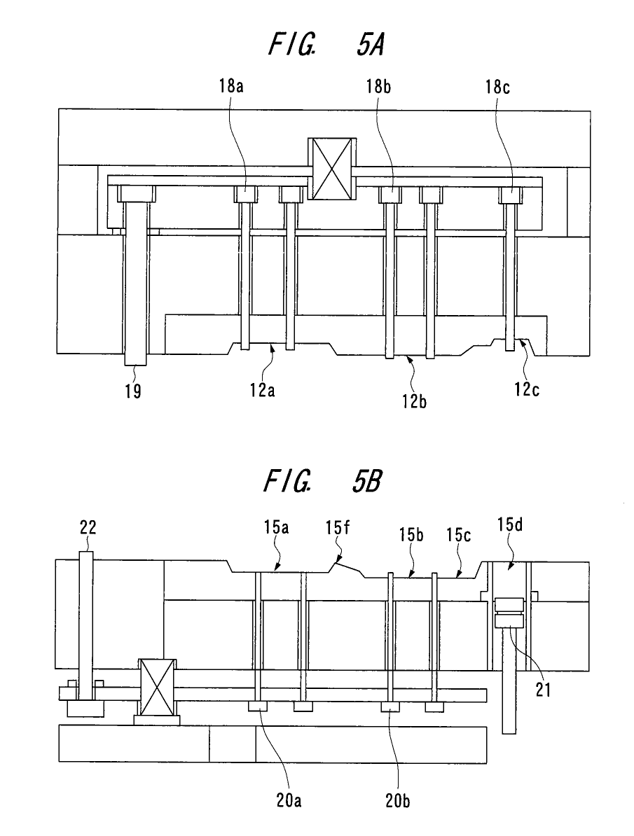

First, the molding step by Embodiment 1 is explained below using FIG. 3 to FIG. 5. FIGS. 3A to 3C are explanatory diagrams for a lead frame to explain the molding step of FIG. 2 in detail. FIG. 3A shows the lead frame before a resin inflow processing, FIG. 3B shows the lead frame after a resin inflow processing, and FIG. 3C shows the lead frame by which unload processing is done after gate break processing. FIGS. 4A and 4B are plan views showing the example of outline structure of a metal mold, FIG. 4A is a plan view of an upper die, and FIG. 4B is a plan view of a lower die. FIGS. 5A and 5B are drawings showing the example of section structure between A-A′ in the metal mold of FIGS. 4A and 4B, FIG. 5A is a cross-sectional view of an upper die, and FIG. 5B is a cross-sectional view of a lower die.

The lead frame to which die bonding of the semiconductor chip 9 was done on the tab of frame body 100, and wire bonding of this semiconductor chip 9 and lead 3 of frame body 100 was done is shown by FIG. 3A. This lead frame showed 1 row of the lead frame of FIG. 1, and is provided with gate part 4 and runner part 7. And mold resin is allowed to flow into this lead frame by using an upper die and a lower die.

So, as shown in FIG. 3B, the lead frame will be in the state of having mold resin 10a of a cavity part having included semiconductor chip 9 and the inner lead used as a part of regions of lead 3, remaining resin 10b of gate part 4, remaining resin 10c of runner part 7, and remaining resin such as a cull part which is not illustrated. Among them, the remaining resin 10c of runner part 7 exists only in one side of a lead frame and is formed in the upper part of hole 8 for resin removal as shown in FIG. 3A.

Subsequently, the portion which ends in remaining resin of the cull part which is not illustrated from remaining resin 10c of runner part 7 is removed as gate break processing by projecting the ejector pin which is equipped to an equipment towards hole 8 for resin removal. By this, as shown in FIG. 3C, the lead frame will be in the state of having mold resin 10a of a cavity part and remaining resin 10b of gate part 4. Then, a molding step is finished in this state and unload processing is performed. In unload processing, a lead frame is mounted on the conveyance rail which equipped both sides with the guide, and is transported towards the cutting device with which a cutting step is performed.

The upper die shown in FIG. 4A is a metallic mold which can mount two matrix type lead frames of 10 rows by 4 columns, for example. In the mounting area of the matrix type lead frame, cavity part 12a used as the die of concave shape and cavity runner part 12b are formed. Cull part 12c corresponding to the supply source of mold resin and connection runner 12d which connects between cull parts 12c are formed in the outside of the mounting area of a matrix type lead frame. Pressure reduction cull part 12e for decompressing cavity part 12a is formed in the both ends of connection runner 12d. Hole 13 for a return-pin drive required when thrusting an upper die off after flowing in mold resin, convex wedge 14 for aligning an upper die and a lower die, and etc. are formed as other structures.

The lower die shown in FIG. 4B has structure corresponding to the upper die mentioned above. It has cavity part 15a used as the die of concave shape and cavity runner part 15b in the mounting area of a matrix type lead frame like an upper die. Branch runner part 15c is formed as a passage which connects cavity runner part 15b of the lead frame of 2 rows. In the lower die, pot parts 15d corresponding to cull part 12c of an upper die and pin raising part 15e which corresponds to pressure reduction cull part 12e of an upper die and which is used for raising a pressure reduction opening-and-closing drive pin are formed. Hole 16 for a return-pin drive required when thrusting a lower die off after flowing in mold resin, concave wedge 17 for aligning an upper die and a lower die, and etc. are formed as other structures.

Processing which allows mold resin to flow in is performed by sandwiching a lead frame by such an upper die and a lower die and supplying mold resin to pot part 15d. The mold resin supplied to pot part 15d passes cavity runner parts 12b and 15b located in both faces of a lead frame via branch runner part 15c, and is poured in the die formed by cavity parts 12a and 15a.

Here, the section structure between A-A′ which is a resin inflow path from cull part 12c and pot part 15d of FIGS. 4A and 4B to cavity parts 12a and 15a has become as shown in FIGS. 5A and 5B, for example. Let the line between A-A′ in FIGS. 4A and 4B pass along cavity runner parts 12b and 15b and branch runner part 15c for convenience of explanation.

The upper die shown in FIG. 5A has cavity part 12a, cavity runner part 12b, and cull part 12c, and further has ejector pin 18a formed so that it could project in cavity part 12a, ejector pin 18b formed so that it could project in cavity runner part 12b, ejector pin 18c formed so that it could project in cull part 12c, and return pin 19 corresponding to hole 13 of FIG. 4A. Although illustration is not done, it has the pressure reduction opening-and-closing drive pin formed so that it could project in pressure reduction cull part 12e.

The lower die shown in FIG. 5B has cavity part 15a, cavity runner part 15b, branch runner part 15c, pot part 15d, and gate port 15f, and further has ejector pin 20a formed so that it could project in cavity part 15a, ejector pin 20b formed so that it could project in cavity runner part 15b and branch runner part 15c, plunger 21 used as the piston for sending out the mold resin set to pot part 15d, and return pin 22 corresponding to hole 16 of FIG. 4B. Although illustration is not done, it has a plunger for pin raising which pushes up a pressure reduction opening-and-closing drive pin at pin raising part 15e.

When allowing the mold resin to flow in, it is carried out by sandwiching a lead frame by such an upper die and a lower die and supplying mold resin to pot part 15d. The mold resin supplied to pot part 15d is sent out by plunger 21, passes cavity runner parts 12b and 15b located in both faces of a lead frame via branch runner part 15c, and is poured in the die formed by cavity parts 12a and 15a. And after hardening the flow-in mold resin, when an upper die and a lower die are made to separate from a lead frame by ejector pins 18a, 18b, 18c, 20a, and 20b and return pins 19 and 22, a lead frame will be in the state where it is shown in FIG. 3B.

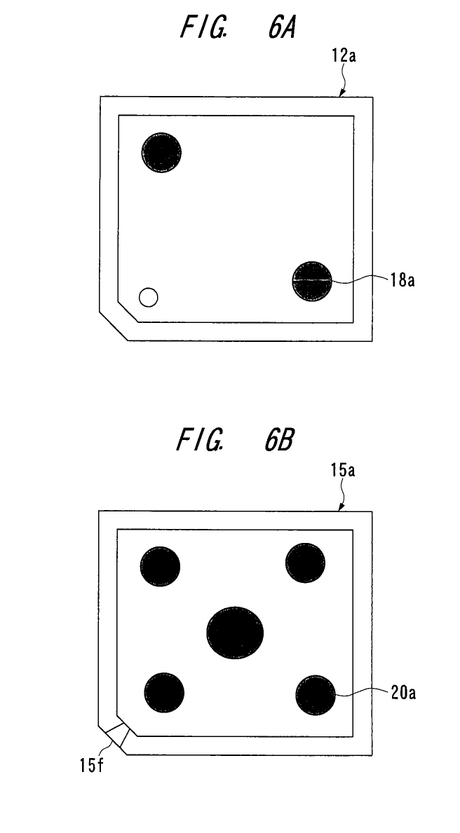

Next, the characteristic form of the upper die and the lower die by Embodiment 1 is explained below using FIGS. 6A and 6B. FIGS. 6A and 6B are enlarged plan views of the cavity part of the metal mold of FIGS. 4A and 4B, FIG. 6A is a plan view of an upper die, and FIG. 6B is a plan view of a lower die.

The gate port which allows mold resin to flow in and the air vent part used as the escaping passages of air are not formed in cavity part 12a of the upper die shown in FIG. 6A. Although the gate port 15f which allows mold resin to flow in is formed in one place of the corner of cavity part 15a, the air vent part is not formed in cavity part 15a of the lower die shown in FIG. 6B.

As mentioned above, 1-3 air vent parts are formed in one cavity part of a conventional metal mold. By the transfer mold method, after performing the mold of multiple times, cleaning of the metal mold using cleaning resin and the mold using resin for mold release for aiming at improvement in the mold-release characteristic of mold resin from a metal mold are performed one by one, but an air vent part is narrow and will be in the state where resin for mold release adhered to this air vent part, easily. For this reason, although manual operation has removed resin for mold release adhering to an air vent part, great time is needed for removal of resin for mold release adhering to the air vent part.

However, since the air vent part is not formed in the cavity part of the upper die and lower die of a metal mold by the present invention as shown in FIGS. 6A and 6B, removal of resin for mold release of an air vent part becomes unnecessary, and the cleaning time of a metal mold can be shortened.

By the way, since the air vent part used as the escaping passages of air is not formed, the air which remains in the die formed by cavity parts 12a and 15a cannot be exhausted by using an air vent part. Thus, before allowing mold resin to flow in the die formed by cavity parts 12a and 15a, it exhausts out of the die by decompressing compulsorily the inside of the die formed by cavity parts 12a and 15a using pressure reduction cull part 12e of an upper die and pin raising part 15e of a lower die via gate port 15f, cavity runner parts 12b and 15b and free passage runner 12d.

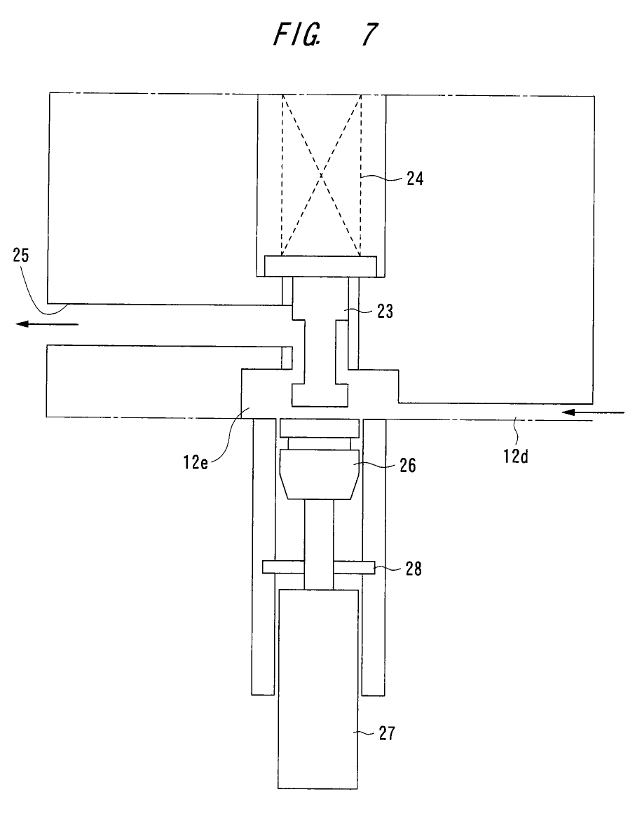

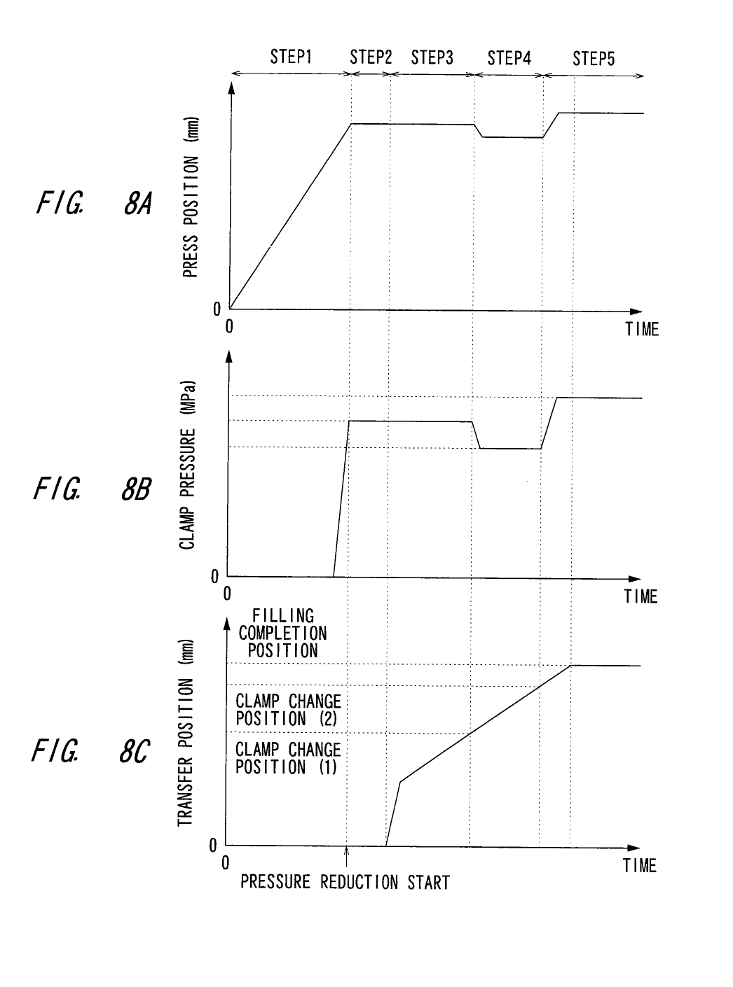

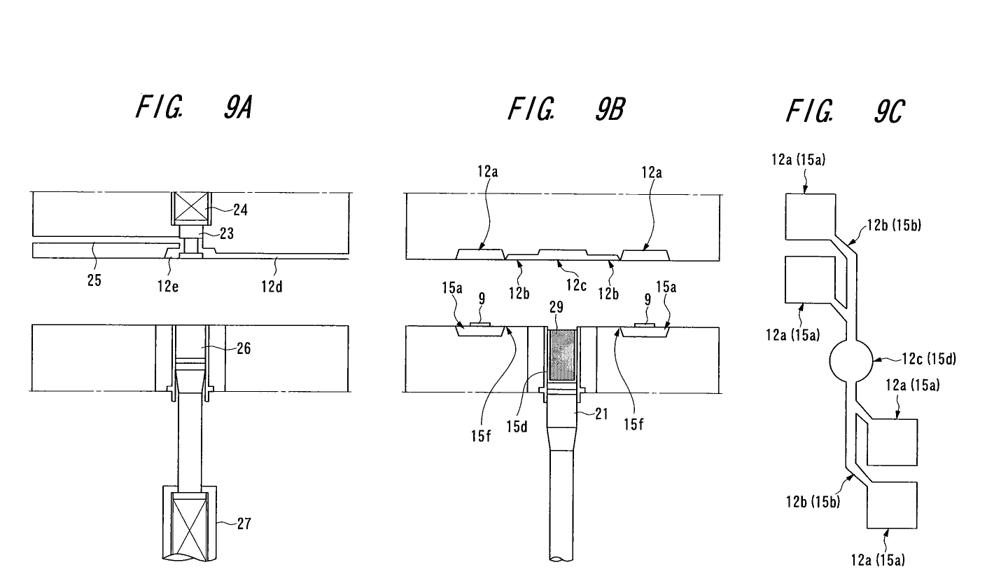

Next, the exhaust method of the air from a cavity part and the inflow method of mold resin to a cavity part by Embodiment 1 are explained below using FIG. 7 to FIG. 14. FIG. 7 is a cross-sectional view showing the example of outline structure of the decompressing part of a metal mold. FIGS. 8A to 8C are examples of the operating sequence in air exhaust processing and a resin inflow processing. FIG. 8A is a press position of a lower die, FIG. 8B is clamp pressure which sandwiches a lead frame, and FIG. 8C is a transfer position of the plunger which extrudes mold resin from the pot part of a lower die. FIG. 9 to FIG. 14 are the drawings showing the example of outline structure of the metal mold which explains air exhaust processing and a resin inflow processing one by one. FIG. “A” are cross-sectional views of the upper die and the lower die of a decompressing part, FIG. “B” are cross-sectional views of the upper die and the lower die of a resin inflow part, and FIG. “C” are the principal part plan views with which the upper die and the lower die of the lead frame installation section are overlapped.

In the upper die of a decompressing part shown in FIG. 7, pressure reduction opening-and-closing drive pin 23 which can be projected in pressure reduction cull part 12e, spring 24 connected with pressure reduction opening-and-closing drive pin 23, air suction hole 25 which sucks air from pressure reduction cull part 12e via the recess formed in the side surface of pressure reduction opening-and-closing drive pin 23, and etc. are formed. The other end of air suction hole 25 is connected to the vacuum hydraulic pump unit. Plunger 26 for pin raising is formed in the lower die of the decompressing part, and it is held by plunger holder 27 and O ring 28.

When exhausting air from the inside of the die formed by cavities 12a and 15a, pressure reduction opening-and-closing drive pin 23 is projected in pressure reduction cull part 12e, and pressure reduction cull part 12e and air suction holes 25 are connected. Hereby, air is exhausted from the inside of the die formed by cavity parts 12a and 15a. This exhausted air is exhausted to air suction holes 25 via cavity runner parts 12b and 15b, connection runner 12d, pressure reduction cull part 12e, and etc. The state of the metal mold in the case of exhausting air from the inside of the die formed by cavities 12a and 15a is shown in FIG. 7. When allowing mold resin to flow in the die formed by cavities 12a and 15a, by raising plunger 26 for pin raising, pressure reduction opening-and-closing drive pin 23 is lifted, pressure reduction cull part 12e and air suction hole 25 are stopped, and the exhaust gas of air is stopped.

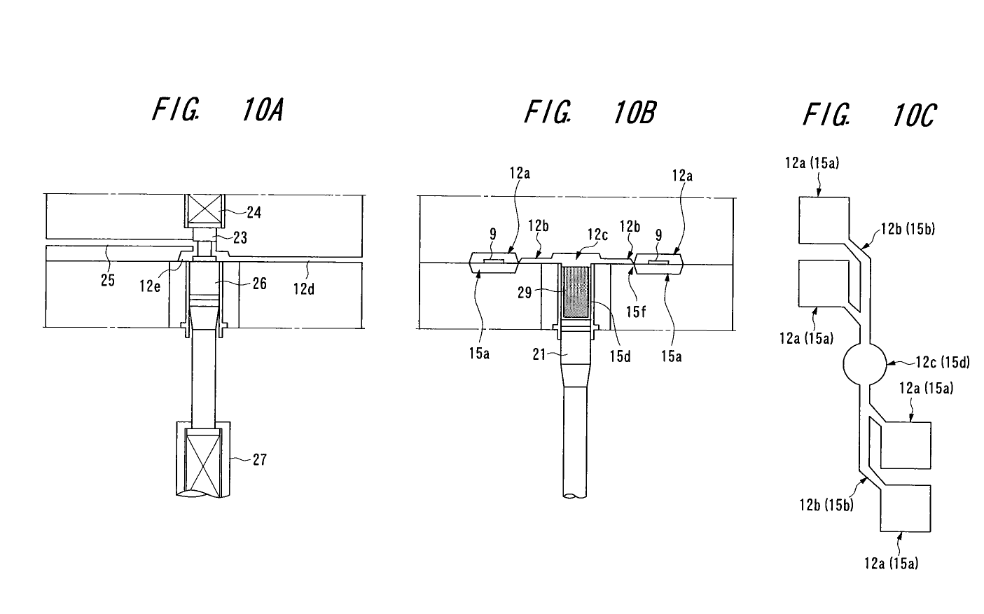

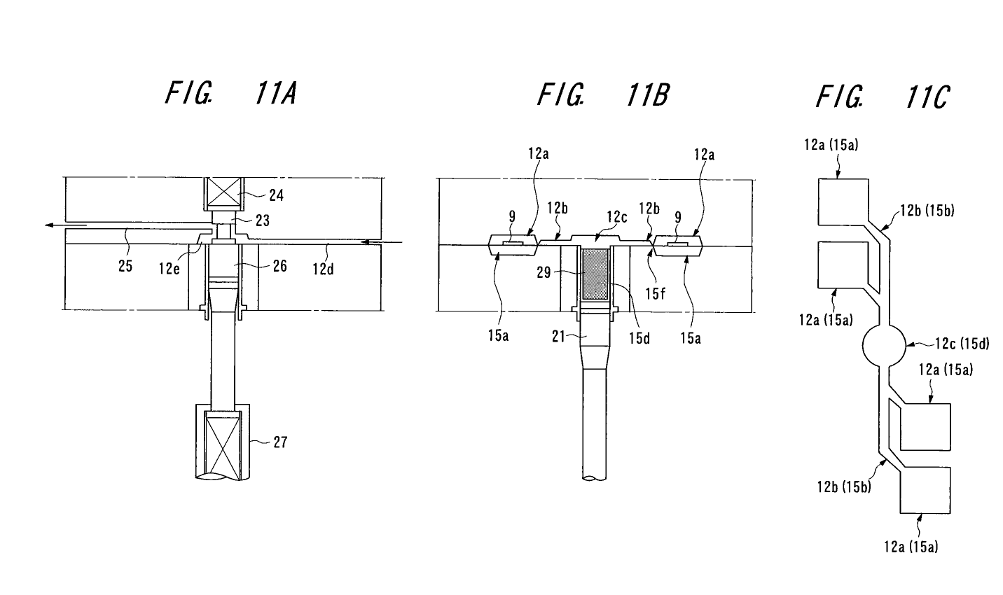

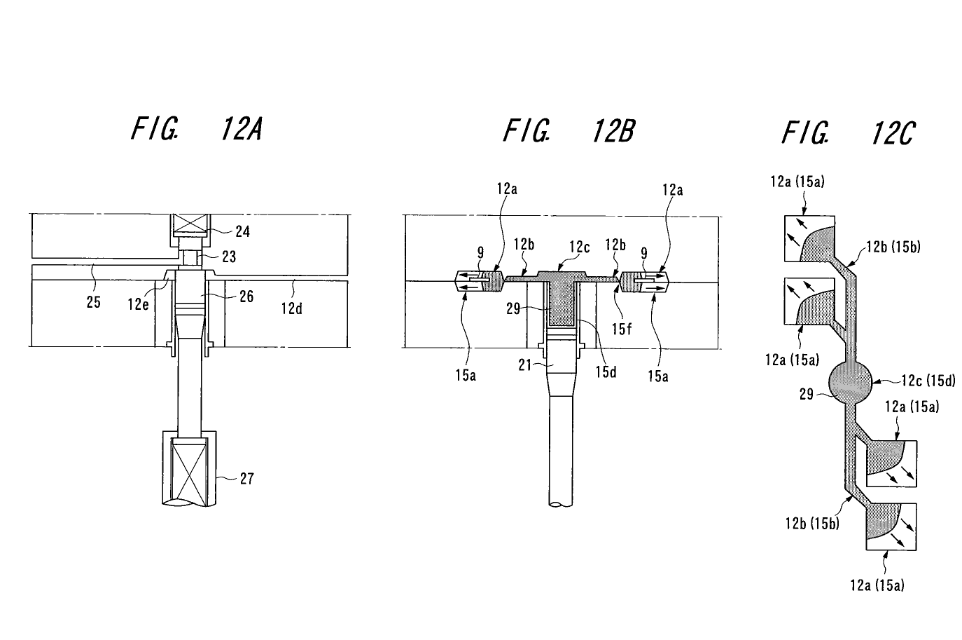

Next, an example of the procedure of air exhaust and mold resin inflow is explained. Here, the case where the air in the die formed of a cavity part could not exhaust thoroughly was assumed, and the method of using three-stage clamps having different pressures such as an intermediate pressure clamp which flows in mold resin into the die after decompressing the inside of the die formed of a cavity part, a low-pressure clamp which exhausts the residual air in the die while injecting mold resin into the die formed of a cavity part, and a high-pressure clamp which forms the mold resin which was filled up in the die formed of a cavity part was adopted.

[Operation procedure 1] A lead frame is first mounted in the predetermined position of a lower die. The state of the metal mold in this stage is shown in FIGS. 9A to 9C. FIG. 9A is a cross-sectional view of the upper die and the lower die of a decompressing part, and the state where the upper die and lower die which were shown in FIG. 7 separated is shown. FIG. 9B is a cross-sectional view of the upper die and the lower die of a resin inflow part, and cavity part 12a formed in the upper die, cavity runner part 12b, cull part 12c, cavity part 15a formed in the lower die, gate port 15f, the pot part 15d into which mold resin 29 was thrown and plunger part 21 are shown. Semiconductor chip 9 mounted in the lead frame is shown in the lower die. FIG. 9C is the plan view with which the upper die and lower die of the lead frame installation section are overlapped, and cavity part 12a of an upper die, cavity runner part 12b, cull part 12c, and cavity part 15a of a lower die, cavity runner part 15b and pot part 15d are shown in an overlapping manner.

[Operation procedure 2] Then, a lower die is raised until the under surface of an upper die and the upper surface of a lower die collide, and a mold clamp is done. At this time, the lead frame is inserted between the upper die and the lower die, and since the flatness of the outer frame of this sandwiched lead frame is good, the lead frame has played the role of the seal ring between an upper die and a lower die. Therefore, it is not necessary to do the vacuum draw of the whole metal mold like the conventional vacuum draw mold method, and the miniaturization of molding equipment can be realized. The state of the metal mold in this stage is shown in Step 1 of FIGS. 8A to 8C and FIGS. 10A, 10B, and 10C. FIGS. 10A, 10B, and 10C show the same part as FIGS. 9A, 9B, and 9C.

[operation procedure 3] Then, the pressure reduction in the die formed by cavity parts 12a and 15a is started. The state of the metal mold in this stage is shown in Step 2 of FIGS. 8A to 8C and FIGS. 11A, 11B, and 11C. FIGS. 11A, 11B, and 11C show the same part as FIGS. 9A, 9B, and 9C. The clamp pressure which sandwiches a lead frame is set, for example as the first pressure of about 55-155 MPa (intermediate pressure clamp).

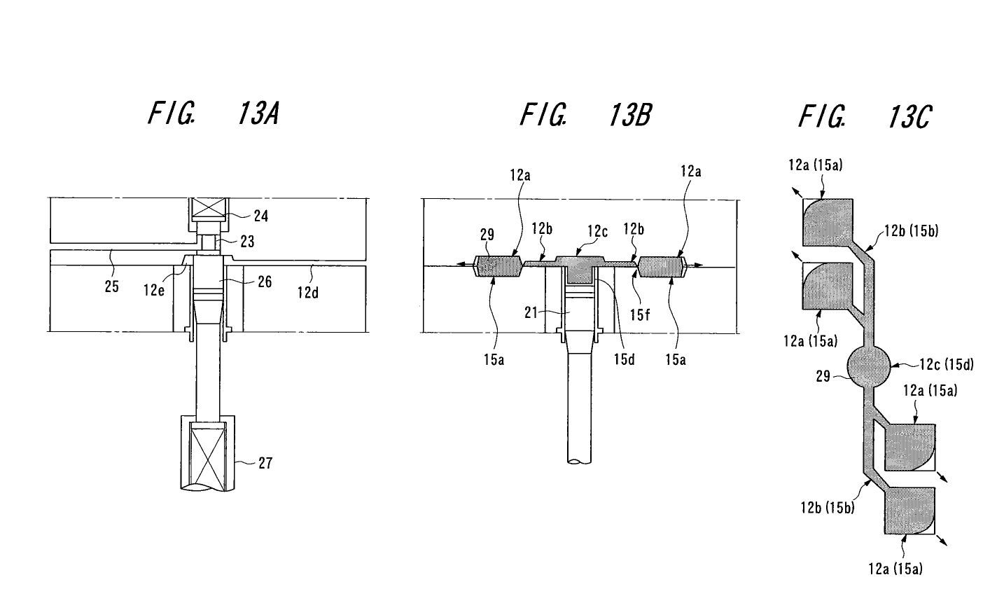

Pressure reduction opening-and-closing drive pin 23 formed in the upper die is projected in pressure reduction cull part 12e. By projecting pressure reduction opening-and-closing drive pin 23 in pressure reduction cull part 12e, the inside of the die formed by cavity parts 12a and 15a is decompressed via gate port 15f, cavity runner parts 12b and 15b, branch runner part 15c, connection runner 12d, pressure reduction cull part 12e, and air suction hole 25, and air is exhausted. By using the lead frame mounted in the lower die for the ceiling of a metal mold and clamping an upper die and a lower die, the inside of the die formed by cavity parts 12a and 15a can be decompressed without leaving a clearance to cavity part 12a of an upper die and cavity part 15a of a lower die which touch a lead frame. The pressure reduction in a die is set, for example as about −70 to −100 kPa. Since the outer frame of the lead frame is used as a seal ring between an upper die and a lower die at this time, as compared with the conventional method which does the vacuum draw of the whole metal mold, the inside of a metal mold cannot fully be decompressed by the pressure reduction method like the present application. However, as compared with the method which does not decompress between an upper die and lower die at all like the mold method using an air vent, the air at the time of later resin inflow which remains in a metal mold decreases dramatically.

[Operation procedure 4] After decompressing the inside of the die formed by cavity parts 12a and 15a, mold resin is allowed to flow into the die. The state of the metal mold in this stage is shown in Step 3 of FIGS. 8A to 8C and FIGS. 12A, 12B, and 12C. FIGS. 12A, 12B, and 12C show the same part as FIGS. 9A, 9B, and 9C. The clamp pressure which sandwiches a lead frame is set, for example as the first pressure of about 55-155 MPa (intermediate pressure clamp).

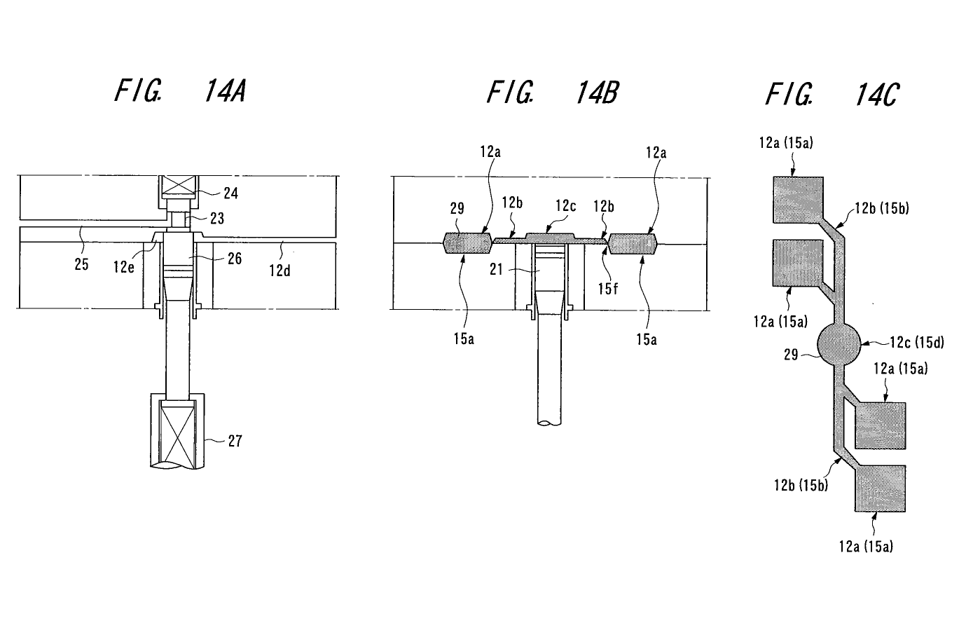

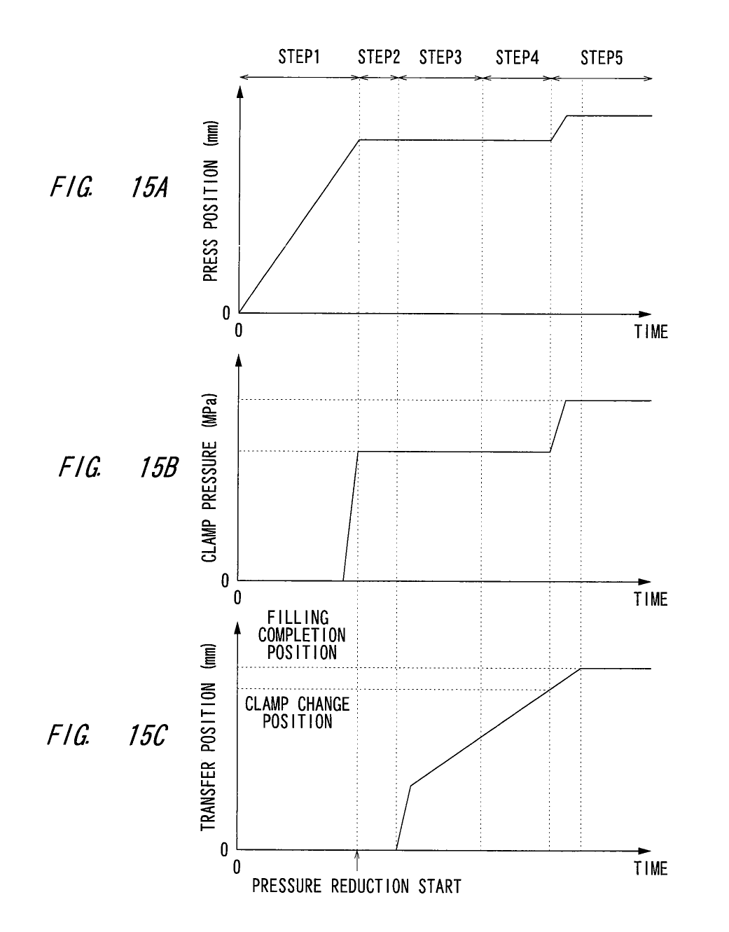

Pressure reduction opening-and-closing drive pin 23 is lifted by raising plunger 26 for pin raising of a decompressing part. Then, by raising plunger 21 of the resin inflow part, mold resin 29 which was thrown into pot part 15d is transported through cull part 12c, branch runner part 15c, cavity runner parts 12b and 15b, and gate port 15f, and is injected into the die formed by cavity parts 12a and 15a. Since the inside of a metal mold is beforehand decompressed at this time, at the time of resin inflow, the resin contamination by residual air etc. do not occur easily, and inflow into a metal mold of mold resin 29 becomes smooth.

[Operation procedure 5] Then, the residual air in the die formed by cavity parts 12a and 15a is exhausted. Although the outer frame of the lead frame is used as a seal ring of an upper die and a lower die in the present application as already stated and the inside of a metal mold is decompressed beforehand, it does not have even sufficient pressure reduction. Therefore, a little air may remain in the corner part in the die formed by cavity parts 12a and 15a in connection with the resin inflow into a metal mold. The state of the metal mold in this stage is shown in Step 4 of FIGS. 8A to 8C and FIGS. 13A, 13B, and 13C. FIGS. 13A, 13B, and 13C show the same part as FIGS. 9A, 9B, and 9C. The clamp pressure which sandwiches a lead frame is set as for example, the second pressure of about 1-55 MPa lower than the first pressure (low-pressure clamp).

A small clearance of about 2-5 μm is made by setting the clamp pressure to the second pressure lower than the first pressure between the lead frame pushing surface of the under surface of an upper die and the upper surface of a lead frame, and the air which remains in the die formed by cavity parts 12a and 15a is exhausted from the clearance. Here, although the pressure which sandwiches the lead frame pinched between the upper die and the lower die falls by lowering clamp pressure to the second pressure, a lead frame remains left to the upper surface of a lower die by the self-weight. As a result, the above-mentioned clearance comes to be formed between the lead frame pushing surface of the under surface of an upper die and the upper surface of a lead frame. Since the inside of a metal mold is decompressed beforehand, the residual air exhausted is little volume as compared with the metal mold of the conventional mold method using an air vent. At this time, in a decompressing part, pressure reduction cull part 12e and air suction hole 25 are stopped, and exhaust of air is stopped. However, into the die formed by cavity parts 12a and 15a, mold resin 29 is flowing in succeedingly. The air which remains in the die formed by cavity parts 12a and 15a is exhausted outside by the pressure of mold resin 29 flowing in, and mold resin 29 is injected into the die formed by cavity parts 12a and 15a. Since the slight air which remains in a metal mold is only exhausted, it is not necessary to open a big clearance between an upper die and a lower die. Since it is not the clearance that mold resin begins to leak from a metal mold outside, mold resin does not leak from a metal mold in the shape of a burr.

[Operation procedure 6] Then, mold resin 29 which was filled up in the die formed by cavity parts 12a and 15a is formed. The state of the metal mold in this stage is shown in Step 5 of FIGS. 8A to 8C and FIGS. 14A, 14B, and 14C. FIGS. 14A, 14B, and 14C show the same part as FIGS. 9A, 9B, and 9C. The clamp pressure which sandwiches a lead frame is set as for example, the third pressure of 155 or more MPa higher than the first pressure (high-pressure clamp).

By setting the clamp pressure to the third pressure and pinching a lead frame, mold resin 29 which filled up in the die formed by cavity parts 12a and 15a can be formed without mold resin 29 leaking out of a lead frame.

[Operation procedure 7] Then, after curing mold resin 29 for predetermined time, plunger 26 for pin raising of a decompressing part and plunger 21 of a resin inflow part are descended to a predetermined position, and the lead frame sealed with mold resin and the cured mold resin in a resin passage are peeled using return pins 19 and 22 and ejector pins 18a, 18b, 18c, 20a, and 20b.

In the molding step which performs the above-mentioned operation procedures 1-7, three clamp pressures of an intermediate pressure clamp which allows mold resin 29 to flow into the die after decompressing the inside of the die formed by cavity parts 12a and 15a, a low-pressure clamp which exhausts the residual air in the die while allowing mold resin 29 to flow into the die formed by cavity parts 12a and 15a, and a high-pressure clamp which forms mold resin 29 which was filled up in the die formed by cavity parts 12a and 15a were used. However, the two-stage clamps having different pressures of a low-pressure clamp which exhausts the residual air in the die while allowing mold resin 29 to flow in the die formed by cavity parts 12a and 15a, after decompressing the inside of the die formed by cavity parts 12a and 15a and a high-pressure clamp which forms mold resin 29 which was filled up in the die formed by cavity parts 12a and 15a can also be used.

FIGS. 15A to 15C are other examples of the operating sequence in air exhaust processing and a resin inflow processing. FIG. 15A shows the press position of the plunger part for pin raising of a lower die, FIG. 15B shows the clamp pressure which sandwiches a lead frame, and FIG. 15C shows the transfer position of the plunger which extrudes mold resin from the pot part of a lower die.

When performing pressure reduction in the die formed of the cavity part (Step 2 of FIGS. 15A to 15C) and inflow (Steps 3 and 4 of FIGS. 15A to 15C) of mold resin into the die formed of the cavity part, the fixed clamp pressure of 1-55 or less MPa is applied (low-pressure clamp). Pressure reduction in the die formed of the cavity part is performed from the air suction hole of a decompressing part by exhausting compulsorily the air in the die formed of the cavity part. Since the outer frame of the lead frame is used as a seal ring between an upper die and a lower die also at this time, as compared with the conventional method which does the vacuum draw of the whole metal mold, the inside of a metal mold cannot fully be decompressed by the pressure reduction method like the present application. However, as compared with the method which does not decompress between an upper die and lower die at all like the mold method using an air vent, the air at the time of later resin inflow which remains in a metal mold decreases dramatically.

After performing pressure reduction in the die formed of the cavity part for predetermined time, mold resin is allowed to flow in into the die. However, the air which remains in the die formed of the cavity part is exhausted outside simultaneously with inflow of mold resin by adopting a low-pressure clamp. Since the inside of a metal mold is decompressed beforehand, at the time of resin inflow, the resin contamination by residual air etc. do not occur easily. The residual air exhausted from a metal mold in connection with resin inflow at the time of a low-pressure clamp is little volume as compared with the metal mold of the conventional mold method using an air vent. Therefore, since the clearance between an upper die and a lower die is small, mold resin does not leak in the shape of a burr from a metal mold outside.

Then, the mold resin which was filled up in the die formed of the cavity part is formed (Step 5 of FIGS. 15A to 15C). On this occasion, by applying the fixed clamp pressure of 155 or more MPa (high-pressure clamp), mold resin can be formed without mold resin leaking out of a lead frame.

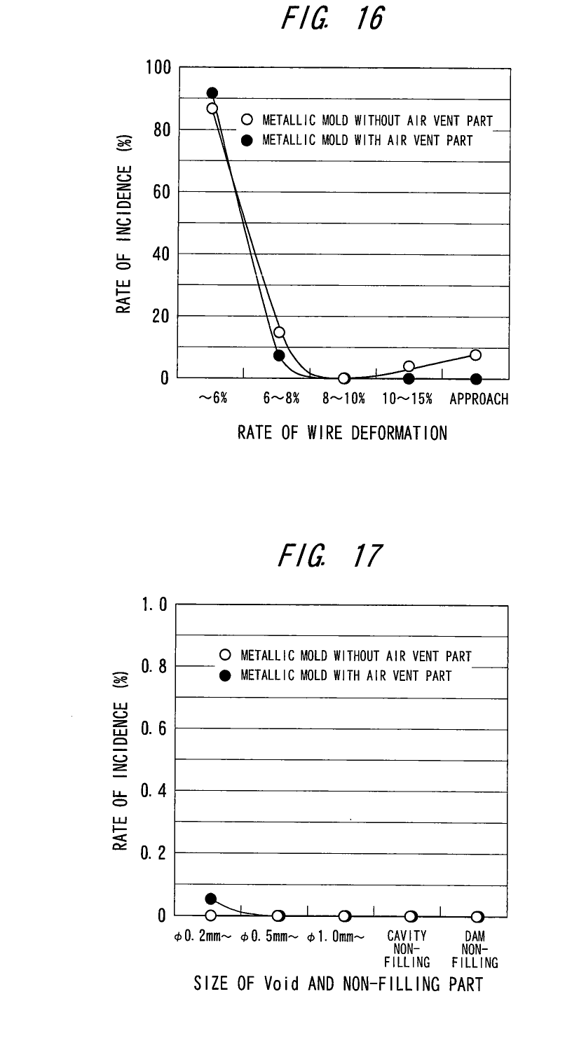

FIG. 16 is a graphical representation showing the deformation characteristics of the wire which connects the pad on a semiconductor chip and the lead of a lead frame. FIG. 16 shows the wire deformation characteristics at the time of forming mold resin using the metal mold which formed the air vent part in the upper die and the lower die and at the time of forming mold resin using the metal mold which does not form an air vent part in an upper die and a lower die. The horizontal axis of FIG. 16 shows the rate of wire deformation, the vertical axis shows the rate of incidence of the rate of wire deformation, and the rate of wire deformation here is the value which divided maximum displacement by loop length. The drawing shows that the rate of incidence of the rate of wire deformation at the time of using the metal mold which does not form an air vent part is almost equivalent to the rate of incidence of the rate of wire deformation at the time of using the metal mold in which the air vent part was formed.

FIG. 17 is a graphical representation showing the rate of incidence of the void and non-filling part which are formed in mold resin. FIG. 17 shows the rate of incidence of the void and non-filling part at the time of forming mold resin using the metal mold which formed the air vent part in the upper die and the lower die and at the time of forming mold resin using the metal mold which does not form an air vent part in an upper die and a lower die. The horizontal axis of FIG. 17 shows the size of a void, and a non-filling part, the rate of incidence of the void of each size and the non-filling part is shown on the vertical axis. The rates of incidence here are occurrences/test total. A drawing shows that a void and the non-filling part of mold resin hardly generate and these rates of incidence are almost equivalent to the case where the metal mold in which the air vent part was formed is used, even if the metal mold which does not form an air vent part is used.

Thus, according to Embodiment 1, by not forming an air vent part in an upper die and a lower die, removal of resin for mold release adhering to an air vent part becomes unnecessary, and the cleaning time of a metal mold can be shortened. By not forming an air vent part, inconvenience of pressure reduction in the die formed of the cavity part by overlooking of removal of resin for mold release adhering to an air vent part or a generation of the foreign substance by sudden peeling of resin for mold release adhering to an air vent part and the non-filling failure of mold resin resulting from adhesion of the foreign substance are prevented, and the manufacturing yield of semiconductor products improves.

The contamination of air at the time of injecting mold resin into the die formed of the cavity part is prevented by exhausting compulsorily the air in the die formed of the cavity part. Therefore, the hold-down of a lead frame can be performed with the low clamp pressure of 55 or less MPa, and the miniaturization of a mold press is attained. Since a lead frame can be used for the ceiling of a metal mold at the time of decompressing the inside of the die formed of the cavity part, for example, it is not necessary to attach the equipment of forming an O ring in the peripheral part of the installed lead frame which has a ceiling function, and a metal mold can be miniaturized. Hereby, the miniaturization of a mold press is attained. Since there is no deficit of an O ring etc. by not forming an O ring, a cavity part can be decompressed stably.

### Embodiment 2

In Embodiment 2, the resin injection processing performed using an upper die and a lower die by the molding step of a lead frame has been the main features like Embodiment 1 mentioned above. Although the metal mold which does not form an air vent part in an upper die and a lower die is used, the exhaust method of the air in the die formed of the cavity part is different from Embodiment 1 mentioned above. That is, in Embodiment 2, a vent similar to the air vent part formed in the existing metal mold is formed in a lead frame, and the air in the die formed of the cavity part is exhausted compulsorily through the vent. Below, the molding step by Embodiment 2 is explained in detail.

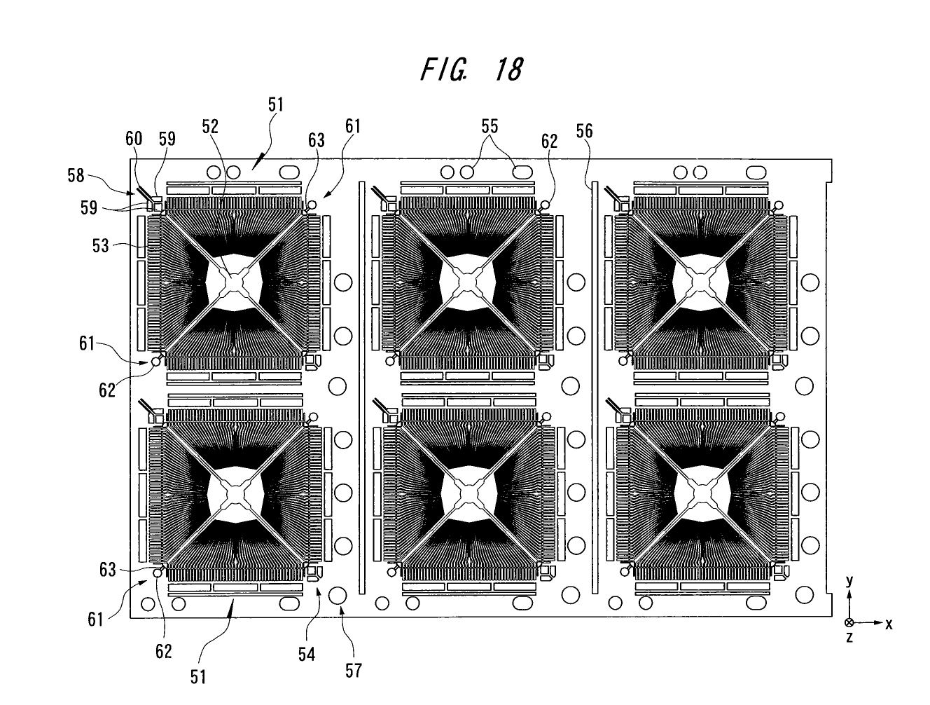

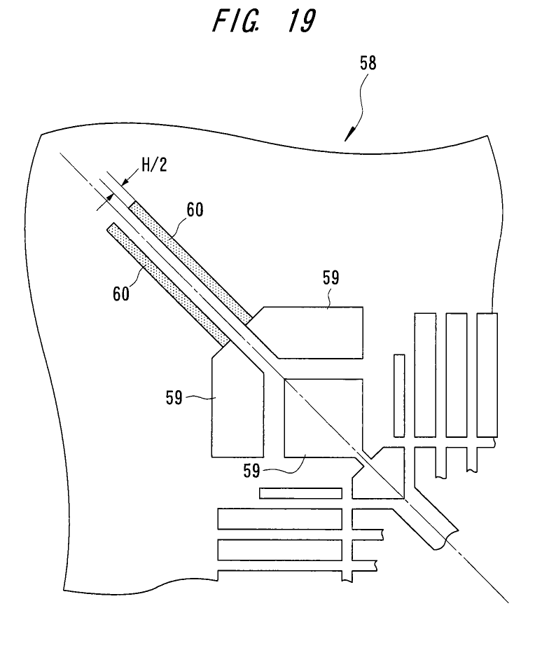

FIG. 18 is a plan view showing an example of the contour in the lead frame by Embodiment 2. The lead frame shown in FIG. 18 has the same structure as the lead frame of a QFP(s)-oriented matrix type shown in FIG. 1 mentioned above, for example, and unit frame 51 corresponding to one semiconductor product is arranged at 6 rows by 2 columns. Only the 3 rows by 2 columns are shown in FIG. 18 among lead frames. In each unit frame 51, tab 52 on which a semiconductor chip is mounted, many leads 53 formed so that tab 52 might be surrounded, gate part 54 which is formed in the corner part of a package region and is provided with the suspension of the shape of a Y shape used as the region of the entrance at the time of allowing mold resin to flow in a package region, a plurality of holes 55 and slits 56 which were formed between unit frames 51 and at the circumference of each unit frame 51, and runner part 57 used as a resin inflow path formed between unit frames 51 which adjoin to a column direction are formed. The suspension formed in gate part 54 is formed in order to reinforce the residual resin which remains in this portion in a molding step. That is, if suspension is not formed, the inconvenience that residual resin will hang down at the time of taking out from a metal mold and is caught in the equipment used in subsequent transportation, a cutting step and a plating step will occur.

As for a different point from the lead frame shown in FIG. 1 mentioned above, flow cavity part 58 which equips with Y shape-like suspension is further formed at the corner part which is in a position symmetrical to the corner part of a package region where gate part 54 was formed with the center of the package region used as the origin. At the circumference of the suspension of the shape of a Y shape of this flow cavity part 58, three holes 59 are formed while leaving Y character, and vent 60 of the predetermined depth is formed to connect with two holes located outside among them, respectively. The vent 60 is formed on the surface of the lead frame (side on which a semiconductor chip is mounted) at the angle of 45 degrees to the X direction (or Y direction). Like the suspension formed in gate part 54, the suspension of the shape of a Y shape formed in flow cavity part 58 is formed in order to reinforce the residual resin which remains in this portion in a molding step.

In order to prevent the mold resin injected into the die formed of the cavity part from leaking to the outside, resin reservoir part 61 is formed in the corner part of two package regions other than gate part 54 and flow cavity part 58. Hole 62 is formed in this resin reservoir part 61, and vent 63 of the predetermined depth further connected with this hole 62 from the direction of the center of a package region is formed. Vent 63 is formed on the surface of the lead frame at the angle of 45 degrees to the X direction (or Y direction).

FIG. 19 is an enlarged plan view of the whole flow cavity part 58 formed in the lead frame. The depth of two vents 60 formed in flow cavity part 58 is determined based on, for example, the board thickness of a lead frame, the forming accuracy of vent 60, and the amount of crushing by a metal mold (for example, 0.01 mm), and can be about 50% of the thickness of a lead frame. For example, the depth of a vent is set to 0.0625 mm when the board thickness of a lead frame is 0.125 mm. The width of vent 60 can be arbitrarily set within a predetermined range. However, it is desirable that the cross-section area of vent 60 formed in flow cavity part 58 and the cross-section area of vent 63 formed in resin reservoir part 61 are made almost the same so that air can be exhausted almost uniformly from three corner parts of a package region. Therefore, the width of vent 60 formed in flow cavity part 58 is set in consideration of the cross-section area of vent 63 formed in resin reservoir part 61. For example, when the width of vent 63 formed in resin reservoir part 61 is 0.2 mm from the reason as mentioned later, each width (reference H/2 in a drawing) of two vents 60 formed in flow cavity part 58 is set to 0.1 mm. From the above, in the lead frame by Embodiment 2, the width of vent 60 formed in flow cavity part 58 was 0.1 mm, and the depth of vent 60 was 0.0625 mm.

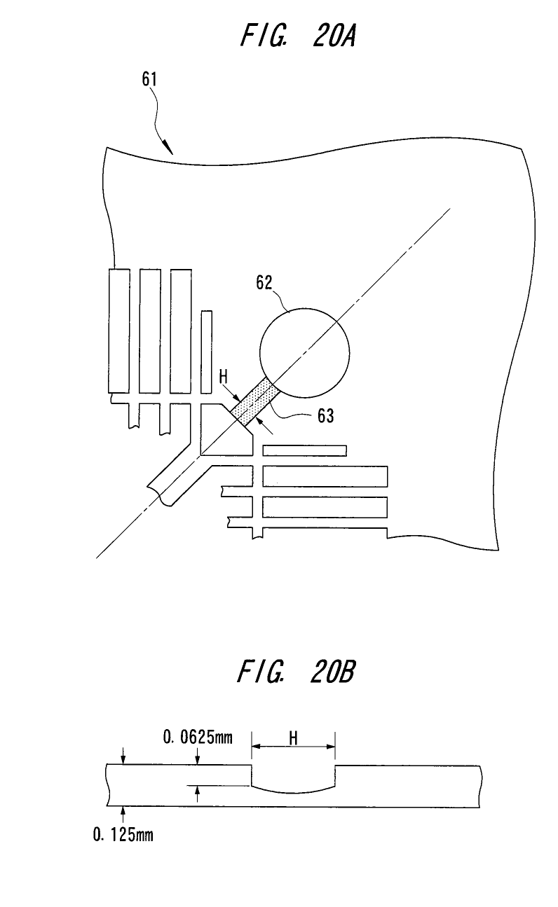

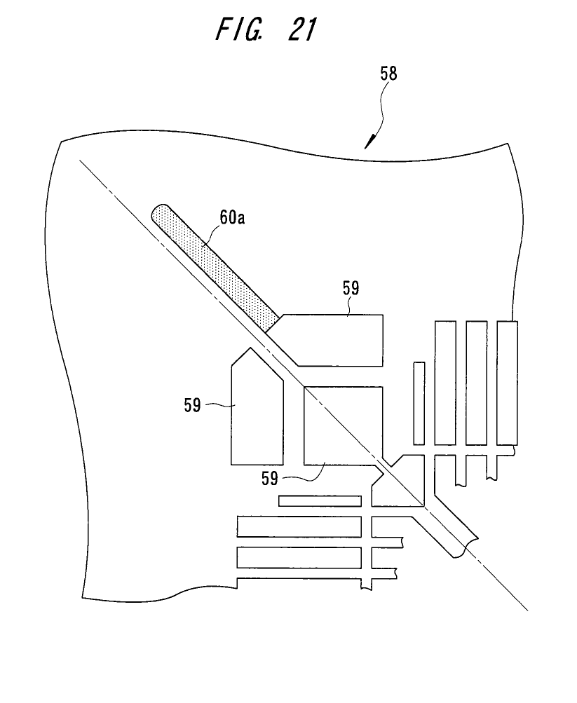

FIGS. 20A and 20B are enlarged views of resin reservoir part 61 formed in the lead frame, FIG. 20A shows the enlarged plan view of the whole resin reservoir part 61, and FIG. 20B shows the enlarged sectional view of vent 63 formed in resin reservoir part 61. Like vent 60 of flow cavity part 58 mentioned above, the depth of vent 63 of resin reservoir part 61 is determined based on, for example, the board thickness of a lead frame, the forming accuracy of vent 63, and the amount of crushing by a metal mold (for example, 0.01 mm) and can be about 50% of the thickness of a lead frame. However, unlike vent 60 of flow cavity part 58 mentioned above, the width of vent 63 cannot be set arbitrarily. That is, the purpose of vent 63 of resin reservoir part 61 is to extrude the air which remains in the above described die instead of the mold resin injected into the die formed of the cavity part. Therefore, mold resin will be extruded when width of vent 63 of resin reservoir part 61 is made wide too much. Therefore, as for the width (reference H2 in a drawing) of vent 63 of resin reservoir part 61, it is desirable to be set to 0.2 mm at maximum. From the above, the width of vent 63 formed in resin reservoir part 61 by Embodiment 2 was 0.2 mm, and the depth of vent 63 was 0.0625 mm.

However, when forming vents 60 and 63 of flow cavity part 58 and resin reservoir part 61 by wet etching, it is difficult to form vents 60 and 63 which have constant depth and whose section form is rectangle. Therefore, although vents 60 and 63 are formed so as to have a depth of 0.0625 mm as shown in FIG. 20B, it is thought that the depth of vents 60 and 63 becomes deeper than 0.0625 mm actually. The setting standard of the width and the depth of vents 60 and 63 of flow cavity part 58 and resin reservoir part 61 mentioned above is an example and is not limited to this. For example, the particle diameter of the filler included in mold resin can be applied to the setting standard of the width and the depth of vents 60 and 63 of flow cavity part 58 and resin reservoir part 61 mentioned above.

FIG. 21 is the first modification of the vent formed in flow cavity part 58. FIG. 19 mentioned above showed two vents 60 connected with two holes 59 located outside, respectively among three holes 59 formed in the circumference of the suspension of the shape of a Y shape of flow cavity part 58. However, one vent 60a connected with one hole 59 of the two above-mentioned holes 59 located outside may be formed at the angle of 45 degrees to the X direction (or Y direction). In this case, in order to make the same cross-section area as that of the vent 63 formed in resin reservoir part 61, the width of vent 60a is set to 0.2 mm, and the depth of vent 60a is set to 0.0625 mm.

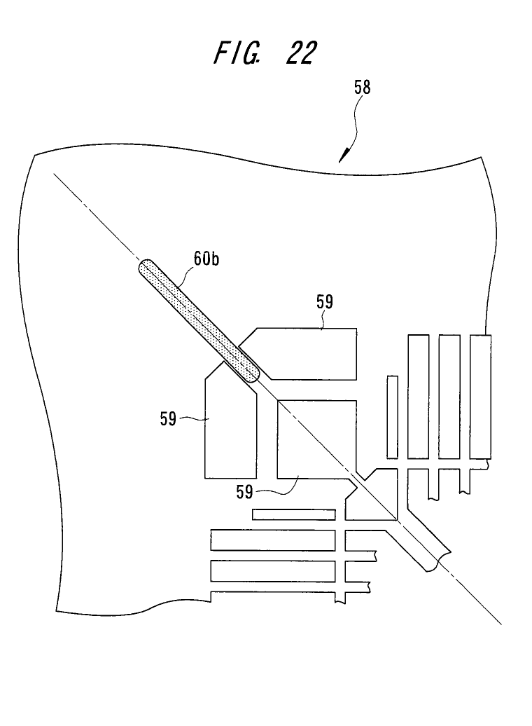

FIG. 22 is the second modification of the vent formed in flow cavity part 58. FIG. 21 mentioned above showed one vent 60a connected with hole 59 of either of two holes 59 which are located outside among three holes 59 formed in the circumference of the suspension of the shape of a Y shape of flow cavity part 58. However, one vent 60b which passes through between two holes 59 located outside and is connected with neither of the three above-mentioned holes 59 may be formed at the angle of 45 degrees to the X direction (or Y direction). In this case, in order to make the same cross-section area as that of the vent 63 formed in resin reservoir part 61, the width of vent 60b is set to 0.2 mm, and the depth of vent 60b is set to 0.0625 mm.

In Embodiment 2, although air is compulsorily exhausted from three corner parts of a package region, air can also be exhausted from one place of flow cavity part 58 without forming a vent in resin reservoir part 61. Also, in Embodiment 2, vents 60 and 63 formed in flow cavity part 58 and resin reservoir part 61 were formed only on the surface of the lead frame. However, vents 60 and 63 may be formed only in a back surface or may be formed in both faces of a front surface and a back surface.

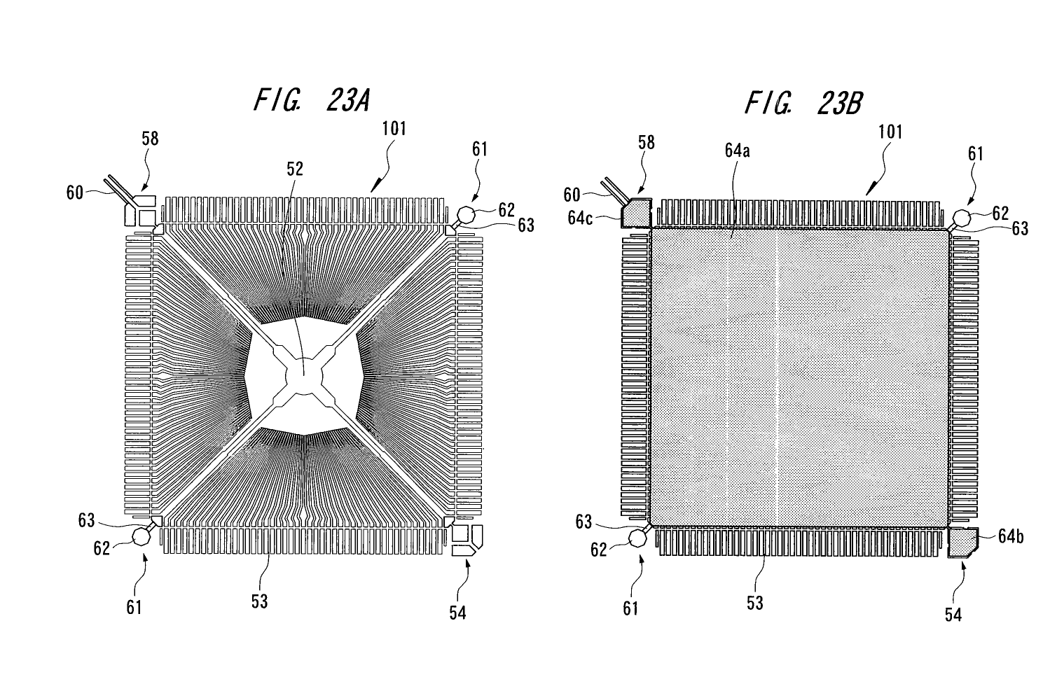

Next, the molding step by Embodiment 2 is explained below using FIG. 23. FIG. 23A shows frame 101 before mounting a semiconductor chip on tab 52, and FIG. 23B shows frame 101 by which mold resin sealing was done, after mounting a semiconductor chip.

After doing die bonding of the semiconductor chip on tab 52 of frame 101 shown in FIG. 23A, wire bonding of this semiconductor chip and lead 53 of frame 101 is done. This frame 101 shows one unit frame 51 of the lead frame of FIG. 18, and it has gate part 54 provided with Y shape-like suspension, one flow cavity part 58 provided with Y shape-like suspension in which vent 60 was formed, and two resin reservoir parts 61 in which vent 63 was formed.

And mold resin is allowed to flow into this frame 101 using an upper die and a lower die. For example, the upper die shown in FIG. 4A and the lower die shown in FIG. 4B mentioned above are used for an upper die and a lower die. That is, as shown in FIG. 6A mentioned above, the gate port which allows mold resin to flow in and the air vent part used as the loophole of air are not formed in cavity part 12a of the upper die. Also, as shown in FIG. 6B mentioned above, the gate port which allows mold resin to flow in is formed in one place of the corner of cavity part 15a of the lower die, but the air vent part is not formed. Therefore, since the air vent part used as the escaping passages of air is not formed in an upper die and a lower die, the air which remains in the die formed of cavity parts 12a and 15a cannot be exhausted using an air vent part. However, the air which remains in the die formed of cavity parts 12a and 15a can be exhausted using vent 60 formed in flow cavity part 58 of a lead frame and vent 63 formed in resin reservoir part 61.

After doing inflow processing of the mold resin, frame 101 will be in the state having mold resin 64a of a cavity part including a semiconductor chip and the inner lead used as a part of regions of lead 53, remaining resin 64b of gate part 54, remaining resin 64c of flow cavity part 58, remaining resin of runner part 57, and remaining resin such as a cull part.

Subsequently, as gate break processing, the portion from remaining resin of runner part 57 to remaining resin of a cull part is removed by projecting the ejector pin provided to equipment towards the hole for resin removal. By this, as shown in FIG. 23B, frame 101 will be in the state of having mold resin 64a of a cavity part, remaining resin 64b of gate part 54, and remaining resin 64c of flow cavity part 58. Then, the molding step is finished in this state and unload processing is performed.

Thus, according to Embodiment 2, the air which remains in the die formed of a cavity part can be exhausted using vent 60 formed in flow cavity part 58 and vent 63 formed in resin reservoir part 61. Therefore, the upper die and lower die in which the air vent part is not formed can be used. Hereby, like Embodiment 1 mentioned above, removal of resin for mold release of an air vent part becomes unnecessary, and the cleaning time of a metal mold can be shortened. Further, inconvenience of pressure reduction in the die formed of the cavity part by overlooking of removal of resin for mold release adhering to an air vent part or a generation of the foreign substance by sudden peeling of resin for mold release adhering to an air vent part and the non-filling failure of mold resin resulting from adhesion of the foreign substance are prevented, and the manufacturing yield of semiconductor products improves.

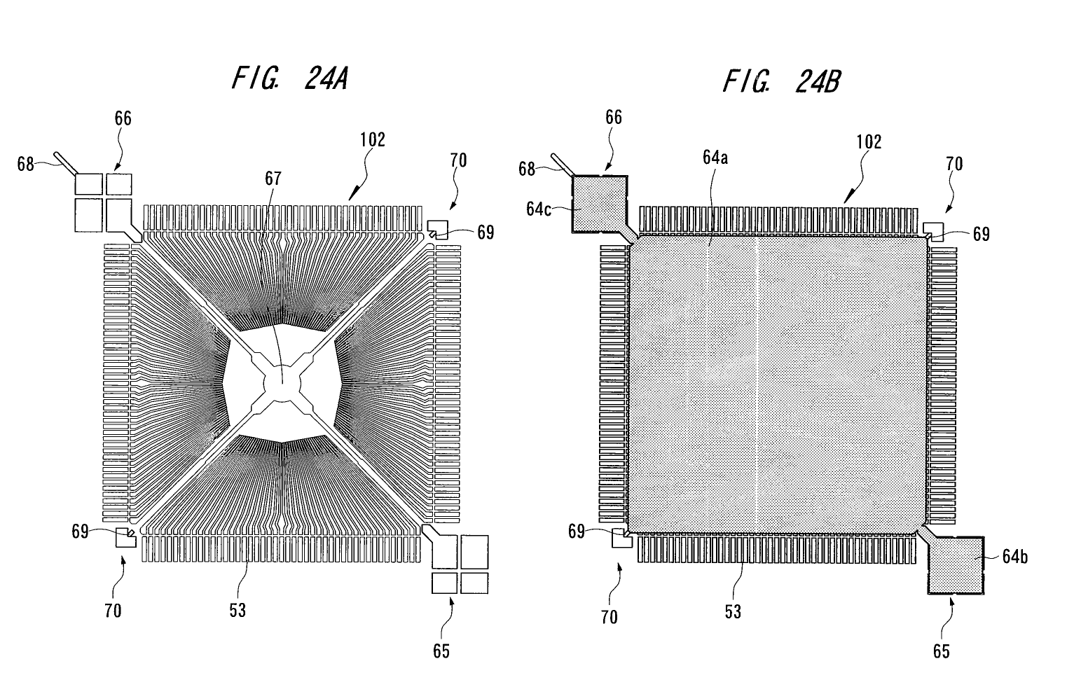

FIGS. 24A and 24B show frame 102 having gate part 65 and flow cavity part 66 with cross-shaped suspension. FIG. 24A shows frame 102 before mounting a semiconductor chip on tab 67, and FIG. 24B shows frame 102 by which mold resin sealing was done, after mounting a semiconductor chip.

This frame 102 also shows 1 unit frame of a lead frame and has gate part 65 provided with cross-shaped suspension, one flow cavity part 66 in which vent 68 provided with cross-shaped suspension was formed, and two resin reservoir parts 70 in which vent 69 was formed. Therefore, even if the upper die with which the gate port which allows mold resin to flow into a cavity part and the air vent part used as the loophole of air are not formed (refer to FIG. 4A and FIG. 6A mentioned above) and the lower die in which the air vent part is not formed although the gate port which allows mold resin to flow into a cavity part is formed in one place of the corner of a cavity part (refer to FIG. 4B and FIG. 6B mentioned above) are used, the air which remains in the die formed of a cavity part can be exhausted using vent 68 formed in flow cavity part 66 and vent 69 formed in resin reservoir part 70 of a lead frame. Hereby, the same effect as a lead frame provided with the suspension of the shape of a Y shape mentioned above can be acquired.

In the foregoing, the present invention accomplished by the present inventors is concretely explained based on above embodiments, but the present invention is not limited by the above embodiments, but variations and modifications may be made, of course, in various ways in the limit that does not deviate from the gist of the invention.

For example, in the Embodiment 1, as shown in FIGS. 6A and 6B, the gate port which allows mold resin to flow into the die formed of the cavity part was formed in the lower die, but it may be formed in an upper die or may be formed in both faces of an upper die and a lower die.

### INDUSTRIAL APPLICABILITY

The manufacturing method of a semiconductor device of the present invention can especially be applied widely to a manufacturing method of a semiconductor device doing a resin seal of the lead frames of a matrix type such as QFP, L-QFP (Low profile-QFP) and T-QFP (Thin-QFP) specification with a transfer mold method.

1. A manufacturing method of a semiconductor device, comprising the steps of:
(a) preparing a metal mold which has a first metallic mold including a plurality of first cavity parts and a first gate port formed in one place of a corner of the first cavity part and a second metallic mold including a plurality of second cavity parts;
(b) preparing a lead frame to which bonding of a semiconductor chip was done;
(c) equipping with the lead frame between the first metallic mold and the second metallic mold, clamping the first metallic mold and the second metallic mold with a first clamp pressure, and decompressing an inside of a die formed by the first cavity part and the second cavity part via an exhaust passage formed by fastening the first metallic mold and the second metallic mold and the first gate port;
(d) stopping pressure reduction in the die formed by the first cavity part and the second cavity part in a state where the first metallic mold and the second metallic mold are fastened with the first clamp pressure, and allowing a resin which seals the semiconductor chip to flow in the die formed by the first cavity part and the second cavity part from a pot part via a resin inflow path formed by fastening the first metallic mold and the second metallic mold and the first gate port;
(e) after the step (d), fastening the first metallic mold and the second metallic mold with a second clamp pressure lower than the first clamp pressure, and allowing the resin to flow in the die formed by the first cavity part and the second cavity part from the pot part via the resin inflow path formed by fastening the first metallic mold and the second metallic mold and the gate port; and
(f) after the step (e), fastening the first metallic mold and the second metallic mold with a third clamp pressure higher than the first clamp pressure.

2. The manufacturing method of a semiconductor device according to claim 1, wherein
at the step (e), residual air in the die formed by the first cavity part and the second cavity part is exhausted.

3. A manufacturing method of a semiconductor device, comprising the steps of:
(a) preparing a metal mold which has a first metallic mold including a plurality of first cavity parts and a first gate port formed in one place of a corner of the first cavity part and a second metallic mold including a plurality of second cavity parts;
(b) preparing a lead frame to which bonding of a semiconductor chip was done;
(c) equipping with the lead frame between the first metallic mold and the second metallic mold, clamping the first metallic mold and the second metallic mold with a second clamp pressure, and decompressing an inside of a die formed by the first cavity part and the second cavity part via an exhaust passage formed by fastening the first metallic mold and the second metallic mold and the first gate port;
(d) stopping pressure reduction in the die formed by the first cavity part and the second cavity part in a state where the first metallic mold and the second metallic mold are fastened with the second clamp pressure, and allowing a resin which seals the semiconductor chip to flow in the die formed by the first cavity part and the second cavity part from a pot part via a resin inflow path formed by fastening the first metallic mold and the second metallic mold and the first gate port; and
(e) after the step (d), fastening the first metallic mold and the second metallic mold with a third clamp pressure higher than the second clamp pressure.

4. The manufacturing method of a semiconductor device according to claim 1, wherein
an air vent part which misses air in the die formed by the first cavity part and the second cavity part is not formed in the first and second cavity parts.

5. The manufacturing method of a semiconductor device according to claim 1, wherein
at one place of a corner of the second cavity part included in the second metallic mold, a second gate port is formed in a position corresponding to the first gate port formed in a corner of the first cavity part included in the first metallic mold.

6. The manufacturing method of a semiconductor device according to claim 1, wherein
in a state where the first metallic mold and the second metallic mold are fastened with the second clamp pressure, a clearance is formed between a lead frame pressing surface of an under surface of the second metallic mold and an upper surface of the lead frame.

7. The manufacturing method of a semiconductor device according to claim 6, wherein
a distance of the clearance is 2-5 μm.

8. The manufacturing method of a semiconductor device according to claim 1, wherein
the first clamp pressure that sandwiches the lead frame is 55-155 MPa.

9. The manufacturing method of a semiconductor device according to claim 1, wherein
the second clamp pressure that sandwiches the lead frame is 1-55 MPa.

10. The manufacturing method of a semiconductor device according to claim 1, wherein
the third clamp pressure that sandwiches the lead frame is 155 MPa or more.

11. The manufacturing method of a semiconductor device according to claim 1, wherein
the exhaust passage formed by fastening the first metallic mold and the second metallic mold is connected to a pressure reduction cull part, and at the step (b), the exhaust passage opens and closes by doing slide drive of a pressure reduction opening-and-closing drive pin included in the pressure reduction cull part with a plunger for pin raising.

12. The manufacturing method of a semiconductor device according to claim 1, wherein
the resin inflow path formed by fastening the first metallic mold and the second metallic mold is connected to the pot part, and at the step (d), the resin thrown into the pot part is extruded by a plunger to the resin inflow path.

13. The manufacturing method of a semiconductor device according to claim 1, wherein
a part of the resin inflow path formed by fastening the first metallic mold and the second metallic mold is used for the exhaust passage formed by fastening the first metallic mold and the second metallic mold.

14. A manufacturing method of a semiconductor device, comprising the steps of:
(a) preparing a metal mold which has a first metallic mold including a plurality of first cavity parts and a first gate port formed in one place of a corner of the first cavity part and a second metallic mold including a plurality of second cavity parts;
(b) preparing a lead frame to which bonding of a semiconductor chip was done in a center of a package region and which has a gate part formed in a first corner part of the package region of a unit frame and a flow cavity part which is formed in a second corner that is in a position symmetrical to the first corner part with a center of the package region used an origin and has a first vent formed therein;
(c) equipping with the lead frame between the first metallic mold and the second metallic mold so that a position of the first gate port of the first metallic mold and a position of the gate part of the lead frame correspond to each other; and
(d) allowing resin which seals the semiconductor chip to flow in a die formed by the first cavity part and the second cavity part from a pot part via a resin inflow path formed by fastening the first metallic mold and the second metallic mold and the first gate port, and exhausting air in the die formed by the first cavity part and the second cavity part from the first vent formed in the flow cavity part of the lead frame.

15. The manufacturing method of a semiconductor device according to claim 14, wherein
a depth of the first vent is about 50% of a board thickness of the lead frame.

16. The manufacturing method of a semiconductor device according to claim 14, wherein
the first vent is formed only in a front surface of the lead frame.

17. The manufacturing method of a semiconductor device according to claim 14, wherein
the first vent is formed only in a rear of the lead frame.

18. The manufacturing method of a semiconductor device according to claim 14, wherein
the first vent is formed in both faces of a front and a rear of the lead frame.

19. The manufacturing method of a semiconductor device according to claim 14, wherein
the lead frame further has a resin reservoir part in which a hole was formed in other different corner parts from the first and second corner parts of the package region of the unit frame and a second vent connected with the hole was formed, and
at the step (d), air in the die formed by the first cavity part and the second cavity part is exhausted from the first vent formed in the flow cavity part of the lead frame and the second vent formed in the resin reservoir part of the lead frame.

20. The manufacturing method of a semiconductor device according to claim 19, wherein
a cross-section area of the second vent formed in the resin reservoir part is the same as a cross-section area of the first vent formed in the flow cavity part.

21. The manufacturing method of a semiconductor device according to claim 19, wherein
a depth of the first and second vents is about 50% of a board thickness of the lead frame.

22. The manufacturing method of a semiconductor device according to claim 19, wherein
the first and second vents are formed only in a front surface of the lead frame.

23. The manufacturing method of a semiconductor device according to claim 19, wherein
the first and second vents are formed only in a rear of the lead frame.

24. The manufacturing method of a semiconductor device according to claim 19, wherein
the first and second vents are formed in both faces of a front and a rear of the lead frame.

25. The manufacturing method of a semiconductor device according to claim 14, wherein
an air vent part which misses air in the die formed by the first cavity part and the second cavity part is not formed in the first and second cavity parts.

26. The manufacturing method of a semiconductor device according to claim 14, wherein
at one place of a corner of the second cavity part included in the second metallic mold, a second gate port is formed in a position corresponding to the first gate port formed in a corner of the first cavity part included in the first metallic mold.

27. The manufacturing method of a semiconductor device according to claim 14, wherein
a suspension is formed in the first and second corner parts of the package region of the lead frame.

28. The manufacturing method of a semiconductor device according to claim 27, wherein
the suspension is a Y shape-like.

29. The manufacturing method of a semiconductor device according to claim 27, wherein
the suspension is cross form.
